(19) United States
(12) Patent Application Publication
(10) Pub. No.: US 2018/0141748 A1
(43) Pub. Date: May 24, 2018

(54) Waste Disposal Device

(71) Applicant: Edgewell Personal Care Brands, LLC, Chesterfield, MO (US)

(72) Inventors: Alexander Chenvainu, Mahwah, NJ (US); Neil MacDonald, Naugatuck, CT (US); Sumanth Chakravarthy, Stamford, CT (US); Condor Shen, New Haven, CT (US); Michael Cheung, Shelton, CT (US)

(21) Appl. No.: 15/644,030

(22) Filed: Jul. 7, 2017

Related U.S. Application Data
(60) Provisional application No. 62/363,587, filed on Jul. 18, 2016.
(60) Provisional application No. 62/359,724, filed on Jul. 8, 2016.

(51) Int. Cl. B65F 1/06; B65F 1/00; B65F 1/16

(52) U.S. Cl. CPC B65F 1/06; B65F 1/0006; B65F 2210/167; B65F 2240/132; B65F 2240/164; B65F 1/163

(57) ABSTRACT

A waste disposal system includes a cassette having a latch feature. The latch feature is received within a cassette interface or secured by a cassette interface. A waste disposal device includes a lid that mitigates disturbance of ambient air surrounding the waste disposal device. A liner clamping system has an associated timing that mitigates against air within the interior space of the waste disposal device from travelling upward through the liner clamping system, past the lid (when the lid is in an open configuration) and outward into the surrounding environment.

### CROSS-REFERENCE TO RELATED APPLICATIONS

This application claims priority to U.S. Provisional Patent Application Ser. No. 62/363,587, filed Jul. 18, 2016, and also claims priority to U.S. Provisional Patent Application Ser. No. 62/359,724, filed Jul. 8, 2016, the entirety of both applications are incorporated herein.

### BACKGROUND OF THE INVENTION

### 1. Technical Field

The present disclosure relates to an apparatus for packaging disposable material or objects into a tubular flexible plastic film material in general, and to devices that utilize cassettes for providing the tubular flexible plastic film material in particular.

### 2. Background Information

Waste disposal devices that include a replaceable liner dispensing cassette are commonly used to throw away odorous waste, such as diapers and litter. In such waste disposal devices, the liner dispensing cassettes are typically positioned near the top of the device in a receiving portion of the waste disposal device and have a length of tubular liner and/or dispense a tubular liner projecting into an internal storage space of the waste-disposal device. New cassettes are loaded into the waste-disposal device and once the liner has been used, the now spent cassette is removed from the waste disposal device.

A key aspect of a waste disposal device is its ability to mitigate propagation of odors from waste products stored within the device. Our investigation has identified at least two device features in the prior art that can unintentionally increase odor propagation. On the one hand, prior art devices often include a liner clamp element that operates to close the liner and thereby keep waste odors within the closed liner. We have discovered, however, that in the process of closing the liner (while the lid is open), some prior art clamping devices cause air within the liner to be pushed out or drawn-out of the liner (e.g., they, at least momentarily, decrease the interior air volume within the liner). As a result, odorous air within the liner is moved outwardly past the open lid and in the direction of the user, Consequently, the user may unintentionally be subjected to a flow of malodorous air. Many prior art waste disposal devices also have a lid pivotally attached to the aft portion of the device. We have also discovered that when the lid is opened (e.g., by manually pivoting the lid about the aft located pivot point, or pivoting the lid via a linkage connected to a foot pedal), the movement of the lid away from the interior volume of the device containing the liner draws a flow of air out of the interior volume. Here again, the user may unintentionally be subjected to a flow of malodorous air. If the prior art device includes both a clamping device and lid arrangement as described above, the user may be subjected to a substantial unpleasant flow of malodorous air upon opening the lid.

A waste disposal device that mitigates any flow of air from the interior of a waste disposal device during use would be an improvement over many existing waste disposal devices.

### SUMMARY OF THE INVENTION

According to an aspect of the present disclosure, a waste disposal device is provided. that includes a lid that that translates back and forth along a path disposed within the contour of the upper portion of the device.

According to another aspect of the present disclosure, a waste disposal device is provided that includes a liner clamping system that is timed to mitigate the propagation of malodorous air from the interior space of the waste disposal device. In one embodiment, an upper liner clamp (or clamps) and a lower liner clamp (or clamps) that are operationally timed relative to one another in a manner that mitigates the propagation of malodorous air from the interior of the waste disposal device outwardly.

According to another aspect of the present disclosure, a waste disposal device is provided that includes a lid, and a liner clamping system that is timed to mitigate the propagation of malodorous air from the interior space of the waste disposal device. In one embodiment, an upper liner clamp (or clamps), and a lower liner clamp (or clamps) that are operationally timed relative to one another, such that the upper liner clamp closes after the lid closes to mitigate or prevent any outward propagation of malodorous air from the interior of the waste disposal device. One or more aspects of the waste disposal device may be separate or integral components, or said differently, one or more components work in concert directly and/or indirectly to achieve such timing.

### BRIEF DESCRIPTION OF THE DRAWINGS

FIG. 1 is a perspective view of a waste disposal device embodiment.

FIG. 2 is a perspective view of a liner cassette embodiment.

FIG. 3 is a perspective view of a cassette interface portion of a waste disposal device.

FIG. 4 is a sectioned perspective view of a cassette interface portion of a waste disposal device.

FIG. 5 is a sectioned side planar view of a cassette interface portion of a waste disposal device.

FIG. 6 is an enlarged portion of the cassette interface shown in FIG. 5.

FIG. 7 is a diagrammatic view of a latch member of a front latch mechanism embodiment.

FIG. 8 is a perspective view of a portion of a cassette interface with a cassette mounted thereon.

FIG. 9 is a perspective view of a portion of a cassette interface.

FIG. 10 is a diagrammatic view of a latch member of an aft latch mechanism embodiment.

FIG. 11 is a diagrammatic view of a cassette biasing mechanism.

FIG. 12 is a partial diagrammatic view of a cassette embodiment.

FIG. 13 is a partial diagrammatic view of a cassette interface embodiment with a cassette mounted thereon.

FIG. 14 is a partial diagrammatic view of a cassette interface embodiment with a cassette.

FIG. 15 is a diagrammatic view of a cassette interface embodiment with a cassette, with a partial break away to illustrate elements.

FIG. 16 is a diagrammatic detailed view of the cassette interface embodiment as shown in FIG. 15.

FIG. 17a is a diagrammatic sectional view of a cassette latch feature according to the present disclosure.

FIG. 17b is a diagrammatic sectional view of a cassette latch feature according to the present disclosure.

FIG. 17c is a diagrammatic sectional view of a cassette latch feature according to the present disclosure.

FIG. 18 is a diagrammatic perspective view of a waste disposal device according to the present disclosure having a front loaded cassette.

FIG. 19 is a diagrammatic partial perspective view of a waste disposal device according to the present disclosure having a front loaded cassette.

FIG. 20 is a diagrammatic partial perspective view of a waste disposal device according to the present disclosure having a front loaded cassette.

FIG. 21 is a sectional perspective view of a portion of a cassette interface embodiment.

FIG. 22 is an exploded perspective partial view of a portion of a cassette interface embodiment.

FIG. 23 is a bottom perspective view of a cassette embodiment.

FIG. 24 is an exploded perspective view of a cassette interface embodiment.

FIG. 25 is a sectional side view of a cassette interface embodiment.

FIG. 26 is an exploded diagrammatic perspective view of a cassette interface embodiment.

FIG. 27 is an exploded diagrammatic perspective view of a cassette interface embodiment, with a top panel removed.

FIG. 28 is a partial perspective view of a cassette interface embodiment.

FIG. 29 is an enlarged view of a portion of the cassette interface embodiment shown in FIG. 28.

FIG. 30 is a top perspective view of a cassette embodiment.

FIG. 31 is a perspective view of a cassette interface embodiment.

FIG. 32 is a diagrammatic view of a latch mechanism embodiment.

FIG. 33 is a diagrammatic view of a latch mechanism embodiment.

FIG. 34 is an exploded diagrammatic perspective view of a cassette interface embodiment.

FIG. 35 is a diagrammatic side view of a waste disposal device embodiment.

FIG. 36 is an isometric top view of a waste disposal device.

FIG. 37 is an isometric top view of a waste disposal device.

FIG. 38 is an isometric top view of a waste disposal device lid.

FIG. 39 is a diagrammatic side view of a waste disposal device embodiment.

FIG. 40 is a diagrammatic top view of a waste disposal device embodiment.

FIG. 41 is an exploded view of a waste disposal device embodiment.

FIG. 42 is a diagrammatic view of a portion of a waste disposal device.

FIG. 43 is a diagrammatic view of a portion of a waste disposal device,

FIG. 44 is a diagrammatic view of a portion of a waste disposal device showing the lid in a closed position.

FIG. 45 is a diagrammatic view of the portion of the waste disposal device shown in FIG. 44, showing the lid in an open position.

FIG. 46 is an exploded view of a waste disposal device embodiment.

FIG. 47 is a diagrammatic view of the portion of the waste disposal device shown in FIG. 46 showing the lid in a closed position.

FIG. 48 is a diagrammatic view of the portion of the waste disposal device shown in FIG. 46, showing the lid in an open position.

FIG. 49 is a diagrammatic view of a waste disposal device having a lid embodiment.

FIG. 50 is a diagrammatic view of a waste disposal device having a lid embodiment.

FIG. 51 is a diagrammatic view of a waste disposal device having a lid embodiment.

FIG. 52 is a schematic illustration shown an operational timing sequence of an upper clamp, a lower clamp, and a lid.

FIG. 53 is a schematic illustration shown an operational timing sequence of an upper clamp, a lower clamp, and a lid.

FIGS. 54-58 are diagrammatic illustrations showing an operational timing sequence of an upper clamp and a lower clamp.

FIGS. 59-63 are diagrammatic illustrations showing a linkage embodiment for actuating lower and upper clamps.

### DETAILED DESCRIPTION

The present disclosure is directed to a waste disposal device 20 that includes a cassette 44 for dispensing a liner material (not shown), to a waste disposal device 20 that includes a cassette interface 34 operable to mount and to retain the cassette 44 within the waste disposal device 20, and to a cassette seat 36 of a waste disposal device 20. “Liner material”, “liner”, “film”, “film material”, “liner film” and other similar terms or variants are interchangeable for purposes of the present disclosure. The waste disposal device 20 is a receptacle for waste products (e.g., diapers, litter, feminine hygiene products, etc.). The liner material provides a bag like structure for receiving the waste products.

As will be evident from the detailed description of embodiments below, the present disclosure provides a waste disposal device 20 having a cassette interface 34 that enables a cassette 44 to be maintained within the waste disposal device 20 by a means other than just gravity, and/or enables a cassette 44 to be at least partially ejected from the cassette interface 34. Indeed, the cassette interface 34 is believed to be new and useful by itself as well; e.g., as a component that could be independently manufactured, or used without a waste disposal device 20. Also as will be evident from the description below, the present disclosure provides a user with a tactile indication (and in some instances an audible indication as well) that the cassette 44 is properly seated and maintained within the cassette interface 34, and therefore within the waste disposal device 20.

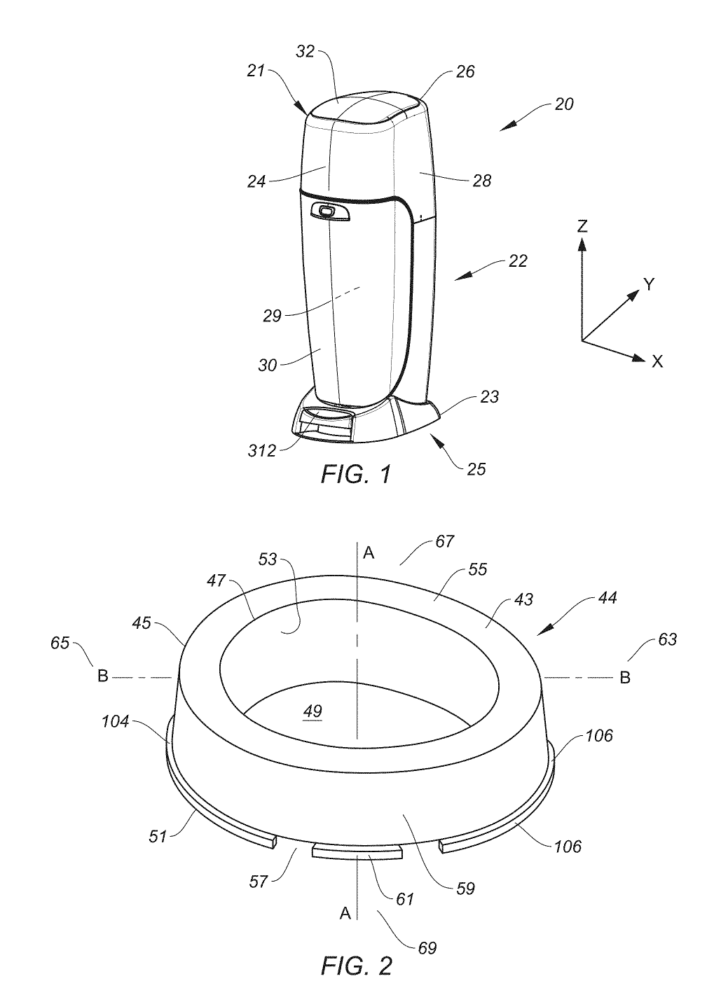

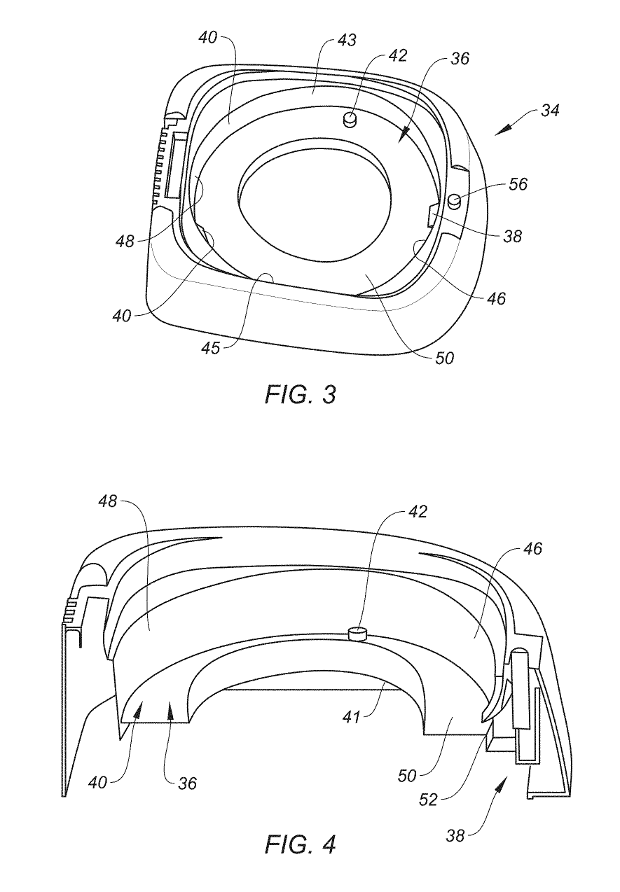

An example of a waste disposal device 20 and a cassette 44 are shown in FIGS. 1 and 2. The waste disposal device has a height defined between a bottom end 25 and a top end 21. The waste disposal device 20 shown in FIG. 1 has a plurality of independent housing portions assembled to form a housing 22 of the waste disposal device; e.g., a base portion attached to an upper portion. Alternatively, the waste disposal device 20 may have a unitary housing structure. The waste disposal device 20 shown in FIG. 1 is shown having a housing 22 with a generally rectangular cross-sectional shape, but the present waste disposal device 20 is not limited to any particular cross-sectional shape; e.g., circular, elliptical, triangular, square, etc. Hence, in some embodiments the waste disposal device 20 may be described as having a forward wall portion 24, an aft wall portion 26, and a pair of side wall portions 28 extending between the forward and aft wall portions (24 and 26 respectively). Waste disposal devices 20 having a cross-sectional shape other than generally rectangular may have other wall portions and/or fewer wall portions. The wall portions may be a continuous piece and/or separate pieces. The waste disposal device 20 includes an interior space 29 for receiving a length of the liner material; e.g., a length of liner material configured to receive and contain waste products. The waste disposal device 20 shown in FIG. 1 includes a pivoting front panel 30 that opens to provide access to the interior space 29. The waste disposal device 20 further includes a lid 32 and a cassette interface 34 (e.g., see FIGS. 3 and 4) both of which are disposed above the interior space 29. The exemplary waste disposal device 20 shown in FIG. 1 includes a lid 32 that is operated between a closed position and an open position by a foot pedal 312 disposed on the front bottom of the waste disposal device 20. The present disclosure is not limited to this embodiment, however; e.g., a lid 32 may be configured to be opened or closed directly by hand. To facilitate the description herein, the waste disposal device 20 may be described in terms of orthogonal axes; e.g., the device may be described as having a length (Z-axis) that extends in a direction between the base 23 and the lid 32 (e.g., a vertical direction when the waste disposal device 20 is standing in its intended manner), a width (X-axis) that extends in a direction between the side wall portions 28, and a depth (Y-axis) that extends in a direction between the forward and aft wall portions 24, 26.

The cassette 44 has a body 43 having an outer perimeter 45 and an inner perimeter 47. The inner perimeter 47 defines a central opening 49 through which waste can be deposited into the liner film. In some embodiments, the outer perimeter 45 defines an outer wall 51. In some embodiments, the inner perimeter 47 defines an inner wall 53. As such, the cassette 44 has one or more surfaces including, for instance, the outer wall 51 and/or inner wall 53, and/or other surfaces described herein. The cassette 44 has an upper surface 55 and a lower surface 57. The cassette 44 also has one or more regions and/or portions, as described herein. The cassette 44 has an upper portion 59 and a bottom portion 61. The cassette 44 has a forward region 63 and an aft region 65 as described with reference to line A-A. The cassette 44 has a first side region 67 and a second side region 69, as described with reference to line B-B. The cassette 44 can further be described to have regions (i.e. front first side, front second side, aft first side, aft second side, etc.), as demonstrated by reference lines A-A and B-B. The cassette 44, as exemplified in this paragraph and throughout the present disclosure, can be defined in regions with respect to a perimeter, a surface, a wall, etc. The cassette 44 can have various shapes and geometries, such that any perimeter, wall, surface or combination thereof can lead to an arcuate or polygonal shape.

At least a portion of a cassette interface 34 is enclosed within the waste disposal device 20 when the lid 32 is disposed in a closed position. In some embodiments, the cassette 44 is, minimally, flush with the exterior of the waste disposal device 20. In many embodiments, the cassette 44 is completely contained within the waste disposal device 20. The cassette interface 34 according to the present disclosure may assume a number of different embodiments.

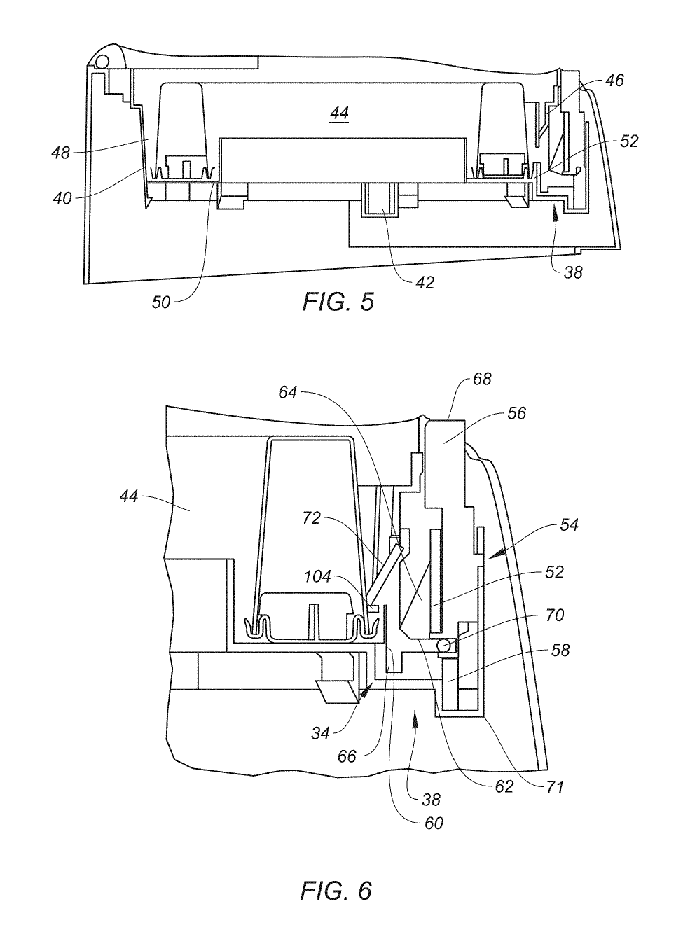

In a first embodiment shown in FIGS. 3-10, the cassette interface 34 includes a cassette seat 36, at least one front latch mechanism 38, at least one aft latch mechanism 40, and may include a cassette biasing mechanism 42. The at least one front latch mechanism 38 and the at least one aft latch mechanism 40 can be described generally as a latch mechanism, and optionally, in some embodiments, are similar and/or utilize at least some of the same components. Alternatively, (or perhaps depending on the waste disposal device 20 configuration), the at least one front latch mechanism 38 and/or the at least one aft latch mechanism 40 are positioned to either side, or, in other embodiments, are a combination of front and to a first side and/or aft and to a second side, etc. . . . Front latch mechanism 38 and aft latch mechanism 40 each have at least one latch member 52. For clarity, latch mechanisms include latch members and optionally other components. The cassette seat 36 is configured to receive at least a portion of the cassette 44 (e.g., see FIG. 5) and may include at least a front wall portion 46 (e.g., that extends substantially lengthwise) and an aft wall portion 48 (e.g., that extends substantially lengthwise). The cassette seat 36 can be any suitable shape to mate the bottom portion 61 and/or bottom wall 57 of the cassette 44. For instance, to the extent the cassette 44 has a flat, stepped, arcuate, undulating or combinations thereof bottom surface, the cassette seat 36 would facilitate at least partial engagement with said cassette 44 (i.e. and thus be flat, stepped, arcuate, undulating, combinations thereof etc.). In some embodiments, the cassette seat 36 matches at least 50% of the bottom portion 61 and/or bottom wall 57. In some embodiments, the cassette seat 36 matches at least 75% of the bottom portion 61 and/or bottom wall 57. In some embodiments, the cassette seat 36 completely engages the cassette 44 bottom portion 61 and/or bottom wall 57 such that the cassette seat 36 mates with substantially all of the bottom portion 61 and/or bottom wall 57. The cassette interface 34 may further include a base wall portion 50 as well, where the base wall portion 50 extends so as to be vertically below the liner cassette 44 when a liner cassette 44 is present within the device 20. FIG. 3 shows an embodiment of a cassette seat 36 that includes a front wall portion 46 and an aft wall portion 48 connected to one another (e.g., continuously extending around the perimeter of the cassette seat 36), a first side wall portion 43 and a second side wall portion 45, and a base wall portion 50. The present disclosure is not limited to this particular embodiment and may have, for instance, wall portions that are discontinuous.

The front latch mechanism 38 includes at least one latch member 52 and a latch biasing mechanism 54. The latch biasing mechanism 54 includes a button 56 configured to actuate the latch member 52. The button 56 is normally disposed in a first position (e.g., extended, as shown in FIG. 6) and selectively translatable to a second position (e.g., depressed), In the second position, the latch biasing mechanism 54 maintains the latch member 52 in a disengaged position.

In the disengaged position, the latch member 52 does not engage a cassette 44 disposed within the cassette seat 36 and therefore does not retain the cassette 44 within the cassette seat 36. In the normal first position, the latch biasing mechanism 54 maintains the latch member 52 in an engaged position. In the engaged position, the latch member 52 may be engaged with a cassette 44 disposed within the cassette seat 36 (if present) and therefore assists in maintaining the cassette 44 within the cassette seat 36. The ability of the present latch mechanisms 38, 40 (as described above and below) to secure the cassette 44 avoids the user having to hold the cassette 44 in place; e.g., during the process of tying off a full liner prior to removal, etc.

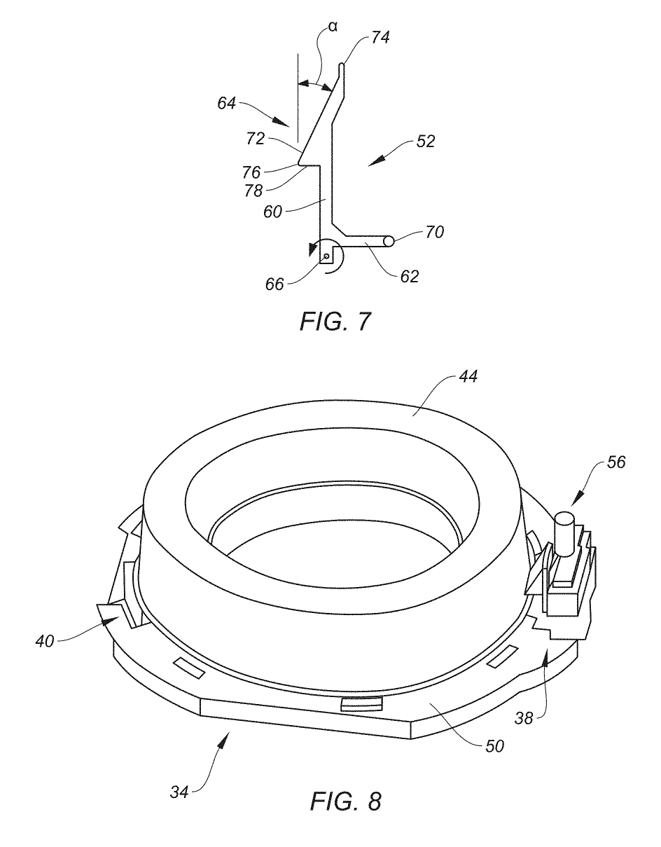

The front latch mechanism 38 as described above, can assume a variety of different configurations. To illustrate, non-limiting examples of front latch mechanisms 38 are provided hereinafter. Referring to FIGS. 4-9, in a first configuration the front latch mechanism 38 includes a substantially L-shaped latch member 52, button 56, and a spring 58. The substantially L-shaped latch member 52 has a first leg 60, a second leg 62, and a head portion 64. The latch member 52 is pivotally attached to the cassette interface 34 adjacent (or at) the point of intersection between the two legs 60, 62. The latch member 52 shown in FIGS. 6 and 7, for example, has a pivot axis 66 extending outward from the figure. As shown in FIG. 6, the pivot axis 66 is disposed below the point of intersection between the two legs 60, 62. Other locations for the pivot axis 66 are possible and demonstrated throughout the present disclosure such that a latch mechanism such as front latch mechanism 38 is able to move between an engaged position and a disengaged position. The head portion 64 (described in more detail below) is attached to the first leg 60 of the member. The second leg 62 is configured for engagement with the button 56 as will be described below.

The button 56 may be configured and mounted (e.g., to the cassette interface 34) for linear translation (e.g., vertical). In some embodiments, the button 56 is configured and mounted for linear translation along both the vertical and horizontal axes (i.e. where the button 56 is disposed on a portion of the waste disposal device 20 other than where the latch member 52 is). In such embodiments, there may be a linkage or a series of linkages between the user contact end 68 and the latch member contact element 70. The button 56 includes a user contact end 68 and latch member contact element 70. The latch member contact element 70 is configured for engagement with the second leg 62 of the latch member 52; e.g., the button member contact element 70 and the front latch second leg 62 have mating features that allow relative pivotal movement. In the embodiment shown in FIGS. 6 and 7, for example, the latch second leg 62 has a cylindrical member that is received in a slot 71 of the latch member contact element 70. As the button 56 is translated, the cylindrical member rotates within the slot 71, but remains within the slot 71. Cylindrical member can be other shapes such as curved, arcuate, faceted, etc. . . . such that the appropriate degree of freedom is provided to enable movement of the latch mechanism as per the geometry of the slot 71.

The button 56 is positioned to improve the user experience with the waste disposal device 20. The button 56, as shown in FIG. 3, is located proximal the forward wall portion 24 of the waste disposal device 20 (i.e. opposite the aft wall portion 26 that would typically be placed against a wall). In other embodiments, the button 56 is located to a side of the waste disposal device 20 such that the button 56 is conveniently located (i.e. proximal to where the user most frequently interacts with the waste disposal device 20) but located such that it avoids inadvertent contact while disposing of waste (which is typically done near the front wall portion 24). In other embodiments, the button 56 is located proximal the aft wall portion 26 to avoid inadvertent contact and also avoid grabbing attention and/or contact from a small child. In some embodiments, as exemplified in FIG. 3, button 56 is covered by the lid 32 (albeit the lid 32 does not interfere with the button 56) such that the button 56 is not accessible except for when an empty cassette 44 needs to be replaced (i.e. when the lid 32 is up).

The spring 58 acts between a fixed surface (e.g., the cassette interface 34) and the button 56, normally biasing the button 56 upwardly. In the embodiment shown in FIG. 6, the spring 58 is shown as a resilient band (e.g., oval shaped) configured to elastically deflect; e.g., when the spring 58 is deflected, the minor axis of the oval is decreased. The present disclosure is not limited to this type of spring 58; e.g., one or more coil springs, flat springs, tension springs_{;} or the like, may be used alternatively.

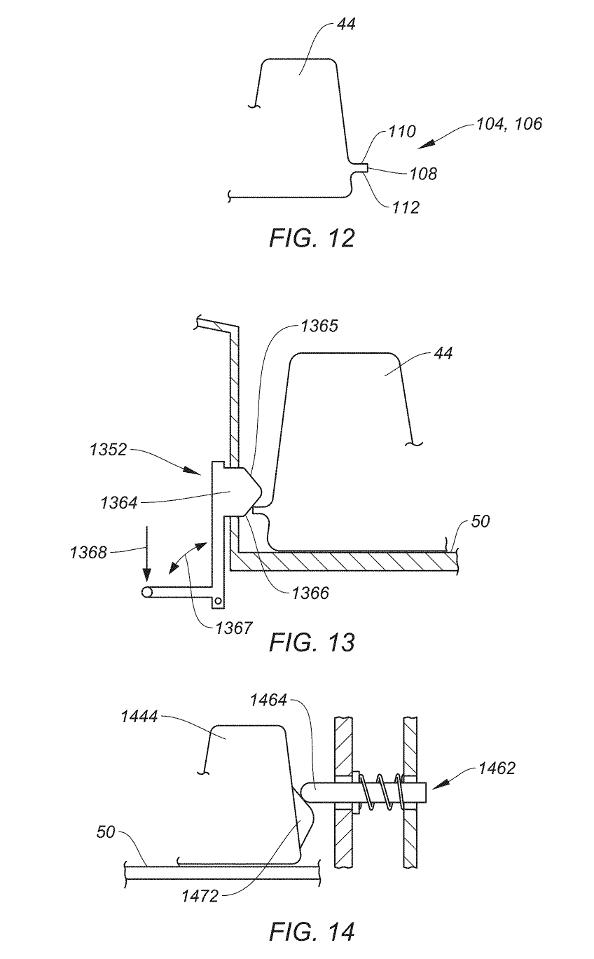

The latch member head portion 64 is configured to mate with a latch feature 104. (e.g., see FIGS. 2 and 12) extending outwardly from the cassette 44, to permit the cassette 44 to be inserted into the cassette seat 36 of the cassette interface 34, and to assist in maintaining the cassette 44 within the cassette seat 36 once the cassette 44 is inserted. For example, in the embodiment shown in FIGS. 6 and 7, the head portion 64 has an exposed ramp surface 72 (disposed at an angle “α” relative to a gravitational vertical line when the device 20 is standing in its intended orientation) extending substantially between a top edge 74 and a bottom edge 76, and a catch surface 78 extending from the bottom edge 76 (in a substantially horizontal direction). Angle α is generally between 0 and 90 degrees. In some embodiments, Angle a is between about 5 and 85 degrees, and more preferably between about 10 degrees and about 60 degrees, such that it is neither parallel nor perpendicular with the x-y plane and thus engages a cassette latch mechanism(s) 104 more easily. The embodiment shown in FIGS. 6 and 7 illustrates an example of a latch member head portion 64 that can be used within the front latch mechanism 38 and the present disclosure is not limited thereto.

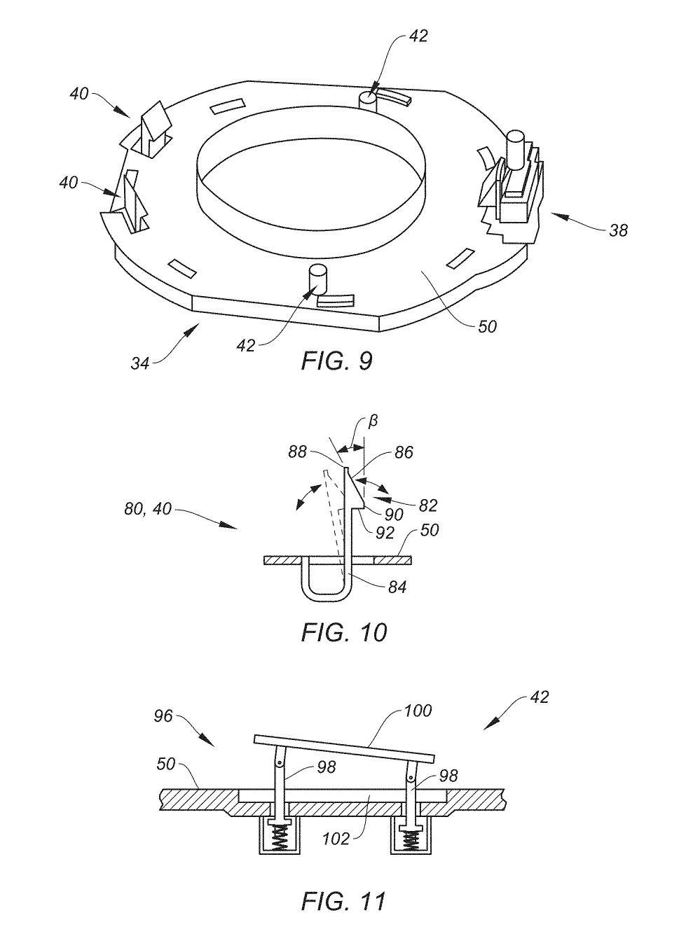

Referring to FIGS. 3, 4, and 8-10, the aft latch mechanism 40 includes at least one latch member 52 configured to be normally biased in an engaged position and operable to be elastically deflected away from the engaged position. The non-limiting embodiment shown in FIGS. 3, 4, 8, and 9 includes two aft latch mechanisms 40. The latch member 52 includes a head portion 82 mounted on a cantilevered stem 84, The head portion 82 is configured to mate with a latch feature 106 (e.g., see FIGS. 2 and 12) disposed on the cassette 44, to permit the cassette 44 to be inserted into the cassette seat 36 of the cassette interface 34, and to maintain the cassette 44 within the cassette seat 36 once the cassette 44 is inserted. For example, in the embodiment shown in FIGS. 9 and 10, the head portion 82 has an exposed ramp surface 86 (disposed at an angle “β” relative to a gravitational vertical line when the device 20 is standing in its intended orientation) extending substantially between a top edge 88 and a bottom edge 90, and a catch surface 92 extending from the bottom edge 80 (in a substantially horizontal direction). In some embodiments, either of catch surfaces 78, 92 are angled upwardly rather than being substantially flat. Catch surfaces 78, 92 are angled upwardly towards leg 60 in embodiments where a greater latch force is useful and/or angled away from leg 60 where a lesser latch force is useful. In some embodiments, catch surfaces 78 and/or 92 have a curved surface. Angle β is generally between 0 and 90 degrees. In some embodiments, Angle β is between about 5 and 85 degrees, and more preferably between about 10 degrees and about 60 degrees, such that it is neither parallel nor perpendicular with the x-y plane and thus engages a cassette latch mechanism(s) 106 more easily. In some embodiments, angles α and β are similar. In other embodiments, angles α and β are not equal. The embodiment shown in FIGS. 3, 4, and 8-10 illustrates an example of a latch member head portion 82 that can be used within the aft latch mechanism 40 and the present disclosure is not limited thereto.

The cassette biasing mechanism 42 is operable to bias a cassette 44 disposed in the cassette seat 36 of the cassette interface 34 upwardly (i.e., vertically upwardly). Biasing the cassette 44 upwardly, facilitates removal of the cassette 44 from the interface 34 (e.g., may at least partially eject the cassette 44 when the respective latch mechanisms are disengaged) and may maintain the cassette 44 engaged with one or both of latch mechanisms 38, 40.

The cassette biasing mechanism 42 may assume a variety of different embodiments. For example, in a first embodiment shown in FIGS. 3-5 and 9, the cassette biasing mechanism 42 includes at least one spring biased button 94 that extends up though a base wall portion 50 of the cassette seat 36. When a cassette 44 is loaded into the cassette interface 34, the spring biased button(s) 94 is depressed some amount and is biased against the cassette 44 to provide a vertical direction force acting against the cassette 44. In a second embodiment (diagrammatically shown in FIG. 11), the cassette biasing mechanism 42 includes at least one push bar assembly 96 in communication with a base wall portion 50 of the cassette seat 36. In this embodiment, the push bar assembly 96 includes at least two spring biased stems 98 connected to one another by a bar 100. Push bar assemblies 96 can be shaped and configured to include at least one spring biased stems 98. Other embodiments include at least one push bar assembly 96, and in other embodiments, at least two push bar assemblies 96, or in other embodiments, at least three push bar assemblies 96. The spring biased stems 98 may be fixedly attached to the bar 100, or may be pivotally attached to the bar 100. Pivotal attachment between the bar 100 and the stems 98 allows the relative orientation of the bar 100 and the base wall portion 50 of the cassette seat 36 to vary during the travel of the push bar assembly 96; e.g., the orientation of the bar 100 and the base wall portion 50 may be parallel or skewed relative to one another. When a cassette 44 is loaded into the cassette interface 34, the push bar assembly(s) 96 is depressed some amount and is biased against the cassette 44 to provide a vertical direction force acting against the cassette 44. The base wall portion 50 of the cassette seat 36 may include a channel 102 for receiving the bar 100 when the push bar assembly 96 is completely depressed, or the bar 100 may be disposed above the base wall portion 50 when the push bar assembly 96 is completely depressed. The above described examples of a cassette biasing mechanism 42 are provided as examples, and the present cassette biasing mechanism 42 is not limited thereto.

Referring to FIGS. 2, 6, and 8 the cassette interface 34 embodiments described above may be utilized with a variety of different types of cassettes 44 and are not, therefore, limited to any particular type of cassette 44. As indicated above, the cassette 44 (regardless of its specific configuration) includes at least one front latch feature 104 (the specific number of front latch features 104 may correspond to the number of front latch mechanisms 38) and at least one aft latch feature 106 (the specific number of aft latch features 106 may correspond to the number of aft latch mechanisms 40). The at least one front latch feature 104 and the at least one aft latch feature 106 can be described generally as a latch feature, and optionally, in some embodiments, are similar and/or utilize at least some of the same components. In some embodiments, there are at least three latch features (i.e. 104 and/or 106). In other embodiments, there are at least four latch features (104 and/or 106). For cassettes 44 having a geometry with a single, perhaps continuous, perimeter such as a circle, or cassettes 44 having multiple sides, as with polygons such as triangles, rhomboids, pentagons, hexagons, octagons and decagons, front latch feature(s) 104 and aft latch feature(s) 106 may be indistinguishable. In some polygonal embodiments, there may be a latch feature on each side. In some embodiments, the latch features are positioned such that they are located about the cassette 44 in a symmetric fashion, that is, symmetric with respect to the lengthwise axis (i.e. z-axis) or widthwise (i.e. x-axis) of the cassette 44. In some embodiments, the latch features are positioned such that they are located about the cassette 44 in an asymmetric fashion, that is, asymmetric with respect to the lengthwise axis (i.e. z-axis) or widthwise (i.e. x-axis) of the cassette 44. In further embodiments, the latch features are positioned at varying heights (or depths) along the y-axis of the cassette 44.

The front latch feature(s) 104 is(are) configured to mate with the head portion 64 of the latch member 52 of the respective front latch mechanism 38, and the aft latch feature(s) 106 is(are) configured to mate with the head portion 82 of the respective latch member 52 of the aft latch mechanism 40. For example, FIG. 12 diagrammatically shows a latch feature 104, 106 that extends outwardly from a surface of the cassette 44, positioned to align with the respective front or back latch mechanism 38, 40 when the cassette 44 is inserted into the cassette seat 36 of the cassette interface 34. The latch feature 104, 106 embodiment shown in FIG, 12 includes an outer edge 108 extending between an upper surface 110 and a lower surface 112. The present disclosure is not limited to the latch feature embodiment shown in FIG. 12; e.g., the latch feature 104, 106 may assume a variety of geometric configuration such as triangular, a curved surface, etc.

As will be described below, in some embodiments of the present disclosure when a cassette 44 is disposed within the cassette seat 36 of the cassette interface 34 the upper surface 110 of each latch feature 104, 106 is engaged with the catch surface 78, 92 of the respective latch mechanism 38, 40. Similarly in the aforesaid embodiments, when a cassette 44 is being inserted into the cassette seat 36 of the cassette interface 34, the lower surface 112 of each latch feature 104, 106 engages the ramp surface 72, 86 of the respective latch mechanism 38, 40. The embodiment shown in FIG. 12 shows the upper surface 110 and lower surface 112 disposed approximately parallel to one another. The present disclosure is not limited to this configuration. For example, the upper and lower surfaces 110, 112 may be non-parallel; e.g., the lower surface 112 may be disposed at an angle (e.g., about 10 degrees) relative to the upper surface 110, such that the distance between the upper and lower surfaces 110, 112 (i.e., the thickness) at the outer edge 108 is less than the distance between the upper and lower surfaces 110, 112 proximate the cassette surface from which the latch feature 104, 106 extends outwardly. In some embodiments, upper and lower surfaces 110 and 112 are represented by angles “φ” and “θ”. Angles φ and θ may be similarly angled, may be similarly or complementarily angled to angles α and/or β, and/or similarly or complementarily angled/shaped as catch surfaces 78 and/or 92.

Angle φ is generally between 0 and 90 degrees. In some embodiments, Angle φ is between about 5 and 85 degrees, and more preferably between about 10 degrees and about 60 degrees, such that it is neither parallel nor perpendicular with the x-y plane and thus engages a cassette latch mechanism(s) 106 more easily. Angle θ is generally between 0 and 90 degrees. In some embodiments, Angle θ is between about 5 and 85 degrees, and more preferably between about 10 degrees and about 60 degrees, such that it is neither parallel nor perpendicular with the x-y plane and thus engages a cassette latch mechanism(s) 106 more easily. In some embodiments, angles φ and θ are similar. In other embodiments, angles φ and θ are not equal.

In addition, all of the latch members 104, 106 may have the same geometric configuration, or different latch members 104, 106 may have different geometric configurations; e.g., to facilitate insertion of the cassette 44 into the cassette seat 36, and/or removal of the cassette 44 from the cassette seat 36. Upper surface 110 and lower surface 112 can be adjacent and or separated by a generally plateaued surface 105, a gap 107 and/or other physical means. The latch feature 104, 106 shown in FIG. 12 is provided as an exemplary embodiment of a front latch feature 104 or a back latch feature 106, or a latch feature that can be used for either. The present disclosure is not limited thereto.

In the operation of the cassette interface 34 embodiments described above, in a first instance wherein a cassette 44 is not disposed within the cassette seat 36 of the cassette interface 34 (e.g., see FIGS. 3.4, and 9), the button 56 and front latch mechanism 38 are normally biased in an engaged position. In the engaged position, the head portion 64 of the front latch mechanism(s) 38 and the head portion 82 of the aft latch mechanism(s) 40 extend into the void defined by the cassette seat 36 of the cassette interface 34. In the engaged position, the user contact end 68 of the button 56 is disposed so that it is possible for a user to depress the button 56 (i.e. the button is in an unbiased, uncompressed, or rest state).

To insert a cassette 44 into the cassette seat 36 of some embodiments of the cassette interface 34 (and thereby load a cassette 44 into the waste disposal device 20), the user may generally vertically, linearly translate a cassette 44 into the cassette seat 36. As the cassette 44 is generally linearly translated into the cassette seat 36, the front latch feature 104 will contact the head portion ramp surface 72 of the front latch member 52 and the aft latch feature 106 will contact the head portion ramp surface 86 of the aft latch member 80. Further translation of the cassette 44 into the cassette seat 36 will cause the front latch member(s) 52 and the aft latch member(s) 80 to deflect outwardly. By generally linearly translate, it is meant that the cassette 44 may be other than in a parallel orientation with respect to the cassette seat 36 (and if the cassette seat 36 is other than a flat surface, the general plane defined by the cassette seat 36), but that the cassette 44 will eventually even-out upon engaging and deflecting the latch mechanism(s). In addition, for those embodiments that include a cassette biasing mechanism 42, at some point in the translation of the cassette 44 into the cassette seat 36, the cassette 44 will engage the cassette biasing mechanism 42 and begin to depress the cassette biasing mechanism 42 from its normal position. As the front latch member 52 is deflected outwardly, the front latch member 52 pivots about its axis 66, which pivotal rotation is resisted by the spring 58. As the aft latch member 80 is deflected outwardly, the cantilevered stem 84 deflects outwardly (i.e. elastically). Once the front and aft latch features 104, 106 attached to the cassette 44 are translated beyond the respective ramp surface 72, 86, the biased front and aft latch members 52, 80 will return (i.e. elastically) to the engaged position within the cassette seat 36. The head portion catch surface 78, 92 of the respective front and aft latch members 52, 80 (now vertically aligned with the respective front and aft latch features 104, 106 of the cassette 44) will subsequently restrain the cassette 44 from being removed from the cassette interface 34 (e.g., see FIGS. 5, 6, and 8) and thereby assist in maintaining the cassette 44 in the cassette interface 34. The above described latch mechanism 38, 40 configurations may provide a tactile signal as the user feels the cassette 44 become secured in the waste disposal device 20. The above described latch mechanism 38, 40 configurations may provide an audible signal as the cassette 44 is loaded into the cassette seat 36. Alternatively, the above described configurations may be modified to include structure that will provide an audible signal. In those embodiments that include a cassette biasing mechanism 42, the cassette biasing mechanism 42 will bias the cassette 44 vertically upwardly to typically produce positive engagement between the respective cassette latch feature upper surface 110 and respective latch member head portion catch surface 78, 92. For further audible feedback, a fin 109 can be disposed proximal any latch feature(s) 104, 106 (either on the cassette or on the waste disposal device), such that a stronger audible signal and/or two audible signals are heard in close succession.

To remove a cassette 44 from the cassette seat 36 of the cassette interface 34 (and thereby remove a cassette 44 from the waste disposal device 20), the user contacts the user contact end 68 of the front latch mechanism button 56 and translates it (e.g., depresses it). Translation of the button 56 causes the spring 58 to elastically deform. As indicated above, the button latch member contact element 70 is engaged with the second leg 62 of the latch member 52 (e.g., to allow relative pivotal movement). As the button 56 is translated, the button 56 causes the substantially L-shaped latch member 52 to rotate about its pivot axis 66. The rotation of the L-shaped latch member 52 causes the head portion 82 attached to the first leg 60 of the latch member 52 to rotate out of the cassette seat 36 of the cassette interface 34. As a result, the latch member head portion 82 disengages with the cassette front latch feature 104 and the head portion 82 longer maintains the cassette 44 within the cassette seat 36. In those embodiments that include a cassette biasing mechanism 42, once the cassette 44 is no longer restrained, the cassette biasing mechanism 42 will bias the cassette 44 vertically upwardly to facilitate removal of the cassette 44 from the cassette interface 34. In some embodiments, the head portion 82 of the aft latch mechanism(s) 40 may remain in its engaged position after the front latch mechanism 38 is disengaged. To remove the cassette 44, the cassette 44 may be rotated slightly to avoid such engagement and the cassette 44 can thereafter be removed.

For simplicity and general reference, the cassette 44 is defined to have a forward end region 63 that generally aligns/engages with aft wall portion 48 of the cassette interface 34. Similarly, the cassette 44 is defined to have an aft region 65 that generally aligns/engages with front wall portion 46 of the cassette interface. Other terms used throughout the present disclosure used to describe the cassette 44 and cassette interface 34 can be understood by virtue of the figures and description, and these general references.

The cassette biasing mechanism(s) 42 are positioned in the cassette interface 34 such that upon disengagement of the latch mechanism(s), at least a portion of cassette 44 is positioned such that it can be more easily removed from the waste disposal device 20. In some embodiments, the cassette biasing mechanism(s) 42 is(are) positioned towards the forward region 63 of the cassette 44 (as it would align when engaged with the aft wall portion 48 of the cassette interface 34) such that upon releasing the latch mechanism(s), the cassette 44 tips upward such that its forward region 63 is vertically upward (i.e. positioned higher) with respect to is aft region 65. In such an embodiment, the forward region 63 is thus easier to grasp as the cassette 44 is positioned skew from the cassette interface 34 thereby lengthening the distance of the cassette 44 outer perimeter 45 and/or inner perimeter 47 from the front wall portion 46, aft wall portion 48, inner wall portion 41, and/or base wall portion 50 of the cassette interface 34.

In other embodiments, the biasing mechanism(s) 42 is(are) positioned towards the aft region 65 of the cassette 44 (as it would align when engaged with the front wall portion 46 of the cassette interface 34) such that upon releasing the latch mechanism(s), the cassette 44 tips upward such that its aft region 65 is vertically upward (i.e. positioned higher) with respect to its forward region 63. In such an embodiment, the aft region 65 proximal the forward wall portion 24 of the waste disposal system 20 is easier to grasp with a shorter reach (as the user is likely to stand in front of the waste disposal device). In yet other embodiments, the biasing mechanism 42 is(are) positioned on a side region 67 and/or 69, and that said is duly positioned higher than the other side portion (i.e. 69 and/or 67, the side that does not have the biasing mechanism(s) 42). In such embodiments, this could be advantageous for consumers who stand proximal to a side wall portion 28 of the waste disposal device 20.

The above described front and aft latch mechanisms 38, 40 are provided as examples of the present disclosure, and the present disclosure should not be construed as being limited to these specific examples. For example, the front and aft latch mechanisms 38, 40 are each described above as having a head portion 64, 82 with an exposed ramp surface 72, 86 (disposed at an angle relative to vertical) and a catch surface 78, 92 (disposed in a substantially horizontal direction or as otherwise taught in the present disclosure). In an alternative embodiment as shown in FIG. 13, at least one of the front or aft latch(s) (both generically shown as 1352), or both, may include a latch member head portion 1364 having opposing ramp surfaces 1365, 1366; e.g., a triangular profile, a semi-circular profile, etc. In FIG. 13, the curved arrow 1367 indicates the rotating movement of the latch member 1352, and the straight arrow 1368 indicates the force direction that may be applied by the actuating the button 56 to move the latch member 1352 between engaged and disengaged positions.

Now referring to FIG. 14, as another example, the features of a latch member and a cassette latch feature may be switched so that features described above as being present in the latch member are now present in the latch feature, and vice versa. For example, the cassette 1444. may include a ramp structure 1472 and the latch member 1452 may include a feature that mates with the ramp structure 1472 affixed to the cassette 1444; e.g., a latch member 1452 having a head portion 1464 configured similar to the latch member shown in FIG. 12. Head portion 1464 is rounded as shown in FIG. 14, or has at least one facet in other embodiments. In some of these other embodiments, head portion 1464 has two facets defining surfaces. In some embodiments, such are similar to the ramp surfaces 1365 and 1366 in FIG. 13.

Referring to FIG. 15, in alternative embodiments the cassette interface 1534 may be configured to receive a cassette 1544 having at least one flange 1502 extending out from a rear surface that is received within a mating aperture 1504 in the aft wall portion 1548 of the cassette seat 1536. Flange 1502 has an upper surface 1510 and a lower surface 1512. The cassette 1544 is inserted into the cassette seat 1536 with the aft portion of the cassette 1544 entering the cassette seat 1536 first. The flange(s) 1502 are inserted into the aperture(s) 1504, and the forward portion of the cassette 1544 is rotated further into the cassette seat 1536. As the cassette 1544 rotates, a forward latch mechanism 1538 is engaged. The cassette 44 rotates between 0 and 90 degrees, depending on the configuration and geometry of the at least one flange 1502, the aperture 1504, as well as the underlying construction of the cassette 44 and cassette interface 34. In these embodiments, if a cassette biasing mechanism 42 is included, it may operate as described above. Once the cassette 1544 is fully inserted into the cassette seat 1536, the forward latch mechanism 1538 maintains the cassette 1544 within the cassette seat 1536 of the cassette interface 1534. FIG. 15 shows a forward latch mechanism 1538 similar to that shown in FIGS. 6, 8, and 9; e.g., the head portion 1582 of a latch member 1552 is engaged with a latch feature 1514 extending outwardly from the cassette 1544. In some embodiments, upper surface 1510, head portion 1582 and/or lower surface 1512 are configured to have one or more a ramp surfaces. The alternative embodiments are not limited to any particular type of forward latch mechanism; e.g., any one of the front latch embodiments described above may be utilized.

In some embodiments, the flange 1502. is proximal the outer perimeter 1545. In some embodiments, the flange is proximal the bottom portion 1561 of the outer perimeter 1545. In other embodiments, the flange is proximal the upper portion 1559 of the outer perimeter 1545.

In yet other embodiments, the flange 1502 is an L shaped structure having a lower portion 1503 and an upper portion 1505. In these embodiments, the cassette latch mechanism connects to the first latch feature via rotation of the cassette about a forward portion of the outer perimeter 1545 of the cassette 1544. This rotation can be described as a “toe-in” movement/connection. The L shaped member is positioned such that the lower portion 1503 of the L points upward towards an upper surface 1555 of the cassette 1544. The L shaped member is positioned on the outer perimeter 45 of the cassette 1544 and in some embodiments, the outer wall 1545 of the cassette 1544. The L shaped member is positioned proximal the bottom surface 1557 of the cassette 1544. The cassette latch mechanism, in some embodiments, has two L shaped members. In these embodiments, the forward latch mechanism 1538 includes an aperture 1504 sized to receive at least the lower portion 1503 of the L shaped member. The aperture 1504 is sized such that the height 1509 of the aperture 1504 is less than the length 1507 of the lower portion 1503 of the L shaped member. In some embodiments, the length 1501 of upper portion 1505 is greater than the height of lower portion 1503. The depth 1511 of the aperture 1504 permits the L shaped member to rotate inside the aperture 1504 in order to achieve a state where the cassette 1544 is secured to the waste disposal device 20 and the lower portion 1503 of the L shaped member is at least partially internal to and secured within the aperture 1504. In some embodiments, the forward latch mechanism 1538 has two apertures 1504, where each aperture 1504 receives a different L shaped member. In further embodiments, the forward latch mechanism 1538 also assists with the at least partial ejection of the cassette 1544 from the waste disposal device 20.

In yet further embodiments, the flange 1504 has an upper surface 110 that is a first ramp surface and/or a lower surface 112 that is a second ramp surface, where the first ramp surface and/or second ramp surface are adjacent or are separated by a plateaued surface 105 or a gap 107.

The cassette 44 and/or latch mechanism provide a connection feature with a geometry that permits selective engagement of the cassette 44 to the cassette interface 34. As such, the cassette 44 is able to engage and disengage the cassette interface. To accomplish this, the cassette 44 and/or latch mechanism have such a connection feature with two features—one permitting engagement, and one permitting disengagement. These features can be on a single piece, or they can be discreet or separate pieces.

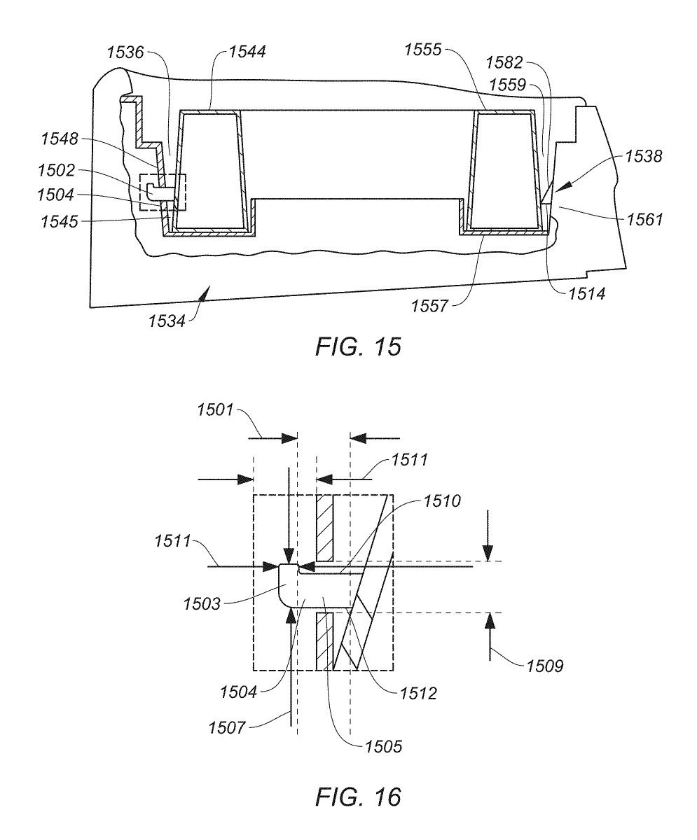

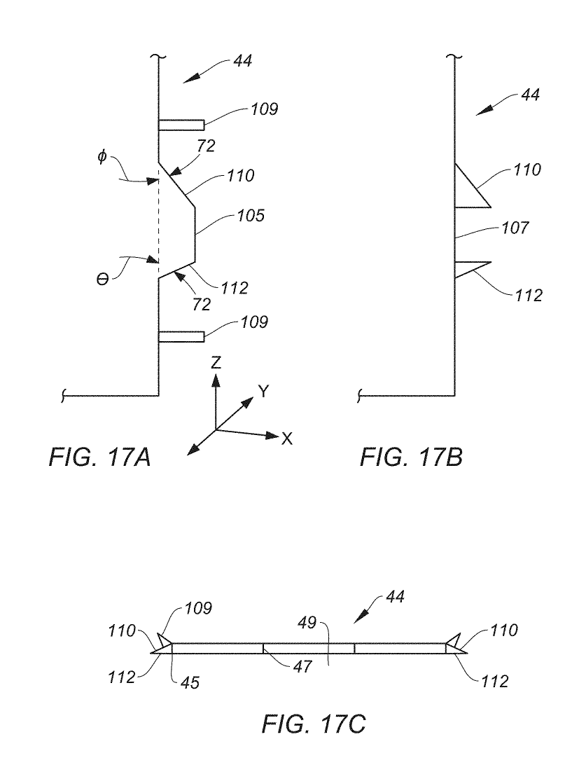

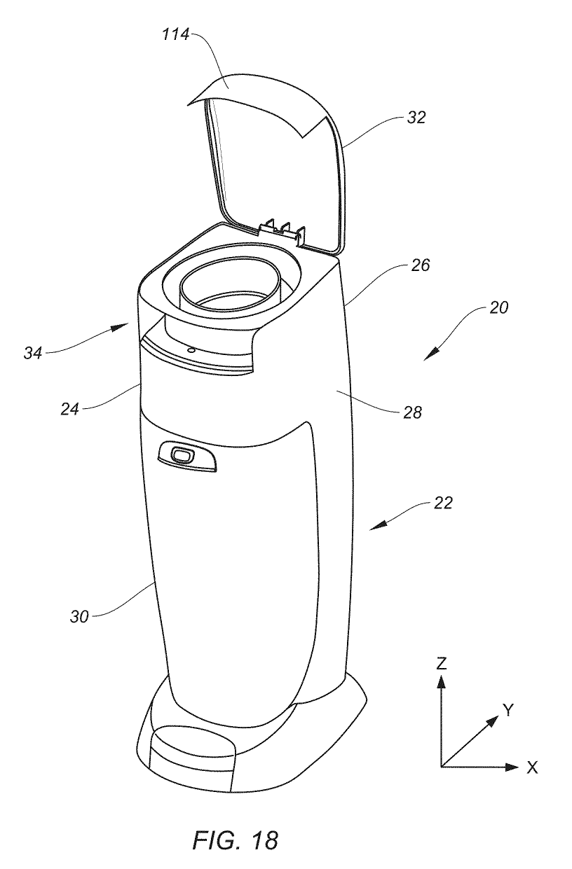

The cassette 44 and/or latch mechanism provide a connection feature with a geometry extending in two directions or in two distinct positions in a single plane, or at least two planes. By way of example, FIG. 7 demonstrates forward latch member having head portion 64 that includes ramp surface 72 sloping in generally the X-Y plane, and includes catch surface 78 sloping generally in the Y-X plane; FIGS. 12-14 and 17a-c show various features on cassette 44 or as part of the cassette interface 34 having two facets that are angled in different directions in the same plane and/or are generally parallel within the same plane; FIGS. 15-16 provide an L shaped member having lower portion 1503 extending generally in the Y-Z plane while upper portion 1505 extends general in the X-Y plane. Similar can be said about the embodiments in FIGS. 18-34, as discussed below.

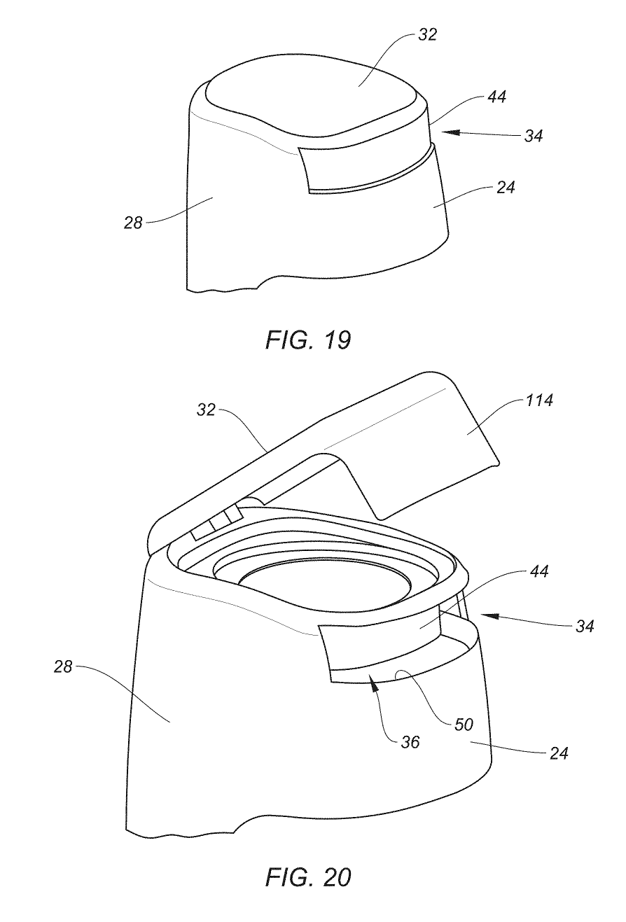

Now referring to FIGS. 18-34, other embodiments of the present disclosure may be implemented in front loading cassette configurations. FIG. 18, for example, shows a waste disposal device 20 with a cassette 44 that is inserted and removed in a direction (e.g., along the Y-axis) substantially perpendicular to the forward wall portion 24. In the embodiment shown in FIG. 18, the device lid 32 includes a forward portion 114 that conceals the front of the cassette 44 when the lid 32 is in the closed position. In some embodiments, lid 32 and forward portion 114 are shaped to have a less abrupt change in curvature. In other embodiments, lid 32 has other portions that extend radially outward similar to forward portion 114 to form a generally cylindrical looking shape. In the embodiment shown in FIG. 19, the lid 32 covers only a portion of the top of the device 20 and the front of the cassette 44 is exposed; e.g., the cassette 44 may have a forward portion configured to blend in with the forward wall portion 24 of the device 22.

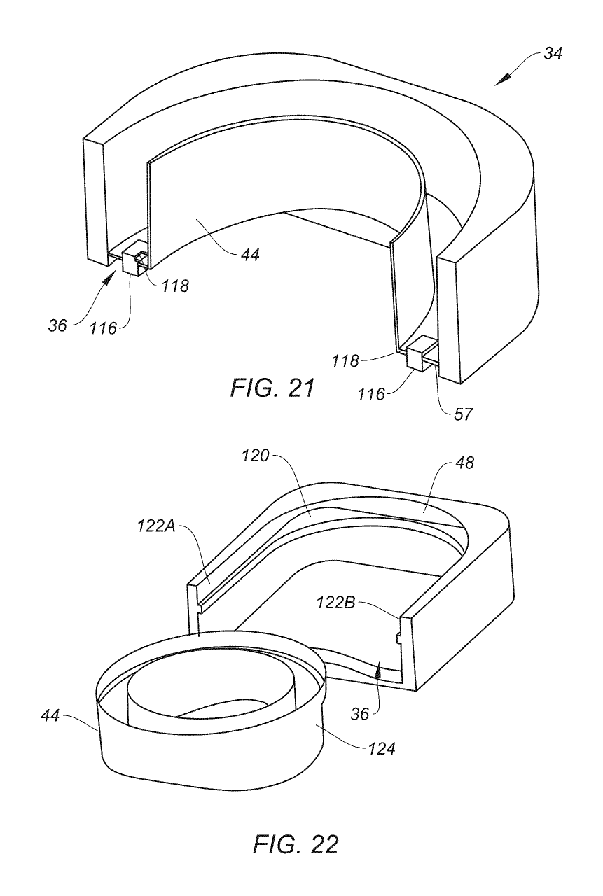

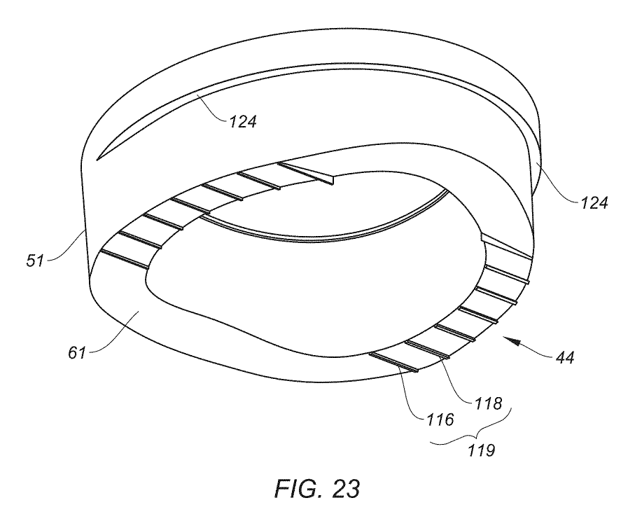

In some embodiments, the cassette 44 and the cassette seat 36 include mating features that guide the cassette 44 as it is inserted into and/or removed from the cassette seat 36, and may also support the cassette 44 when it is disposed within the cassette seat 36. For example, as can be seen in FIG. 20, the cassette 44 may include one or more rails 116 extending out from the bottom portion 61 of the cassette 44, and in some embodiments from the bottom wall 57 of the cassette 44. In some embodiments, one or more rails optionally extend outward from the first side region 67 and/or second side region 69. At least one of the one or more rails 116 aligns with and is received into a mating channel 118 disposed in or on the base wall portion 50 of the cassette seat 36. The mating rail 116 and channel 118 configuration guides movement of the cassette 44 relative to the cassette seat 36 and may also support the cassette 44 relative to the cassette seat 36. In some embodiments, the positioning of the rails 116 and the channels 118 may be reversed. For example, FIG. 21 is a sectioned view that shows the cassette seat 36 having a pair of rails 116 that mate with channels 118 disposed in the lower surface 57 of a cassette 44. In some embodiments, the cassette seat 36 includes one or more shelves disposed on cassette seat side wall portions 122A, 122B, and may also include a shelf disposed in the cassette seat aft wall portion; e.g., the embodiment shown in FIG. 22 shows a shelf 120 example that extends from cassette seat one side wall portion 122A, across the aft wall portion 48, to the opposite cassette seat side wall portion 122B. In these embodiments, the cassette 44 includes at least one flange 124 that mates with the shelf 120; e.g., when the cassette 44 resides within the cassette seat 36, each flange 124 rests on a respective portion of the shelf 120. The bottom perspective view of a cassette 44 embodiment shown in FIG. 23 shows a flange 124 that extends along the side and aft portions of the cassette outer wall 51. Alternatively, or in combination, the cassette 44 and cassette seat 36 may have at least one mating rail 116 and channel 118 (e.g., similar to that described above) disposed in respective side walls of the cassette 44 and cassette interface 34 to guide and/or support the cassette 44 relative to the cassette seat 36. As shown in FIG. 23, some embodiments of cassette 44 include one or more rails 116 and channels 118. The combination of such can form a tread-like structure 119 on at least a portion of cassette 44, such as one or both side portions and/or the forward portion. The tread-like structure 119 has a reciprocal or mating structure having rails 116 and channels 118 on cassette seat 34.

Furthermore, in some embodiments, the upper surface 110 and/or a lid of the cassette 44 can be equipped with reciprocal features (rails 116, channels 118, tread 119) such that one cassette 44 is stackable on a second cassette 44. The structure of rails 116, channels 118 and/or tread 119 enables a mating engagement between cassettes 44 that is streamlined (i.e. the structures are low-profile) and also mitigates movement between the cassettes 44 about the y-axis and x-axis. In some embodiments, the rails 116, channels 118 and/or tread 119 is configured such that such structures extend to the outer perimeter of the cassette lid or upper surface 110.

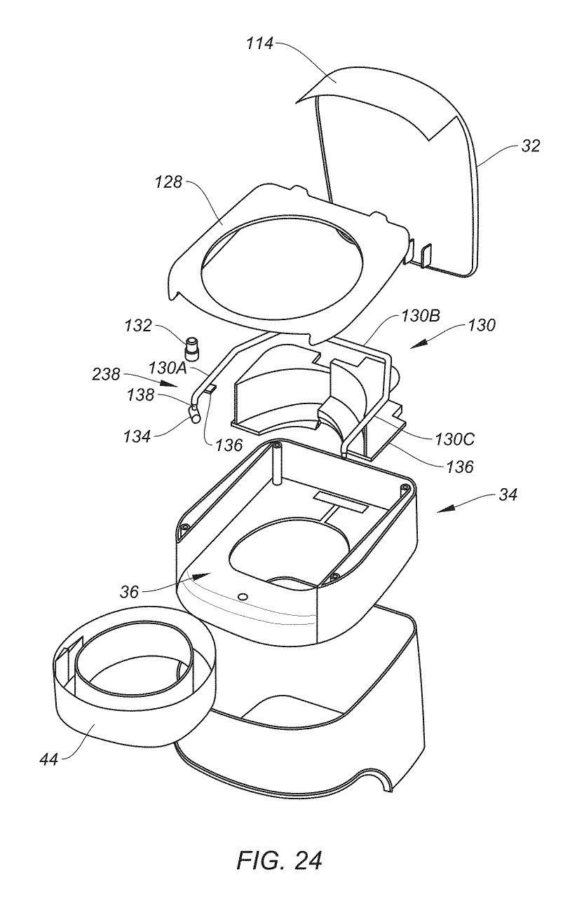

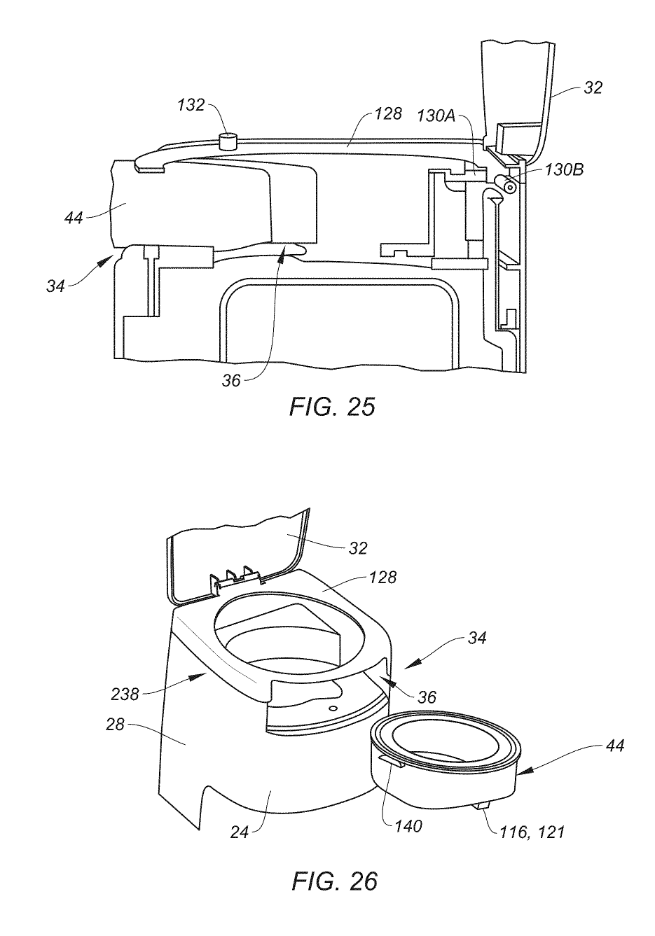

In some embodiments, the cassette interface 34 may include a latch mechanism 238 configured to retain the cassette 44 within the cassette seat 36 once inserted. A variety of different latch mechanisms 238 may be used to retain the cassette 44, and the present disclosure is not limited to any particular type of latch mechanism. FIG. 24 shows an exploded view of a cassette interface 34 embodiment having a top panel 128 and a latch mechanism 238 that includes a U-shaped latch bar 130, at least one button 132, and a latch bar biasing mechanism (e.g., spring 134). The U-shaped latch bar 130 includes a first side portion 130A, and aft portion 130B, and a second side portion 130C. Each side portion 130A, 130C includes a latch tab 136 extending outwardly from the respective side portion 130A, 130C and a biasing post 138. The sectional view shown in FIG. 25 shows the aft portion 13013 of the U-shaped latch bar 130 pivotally retained towards the aft portion of the cassette seat 36. A biasing member 134 (e.g., a spring) acting between a fixed surface (e.g., within the cassette interface 34) and the respective side portion 130A, 130C of the U-shaped latch bar 130 biases the side portion 130A, 130C upwardly (e.g., clockwise rotation in the view shown in FIG. 25), thereby causing the aft portion 130B of the U-shaped latch bar 130 to act as a pivot axis. One or more biasing members 134 may be used to bias the first side portion 130A of the U-shaped latch bar 130 and/or one or more biasing members 134 may be used to bias the second side portion 130C of the U-shaped latch bar 130 in similar manner. Each button 132. (the embodiment shown in FIG. 24 shows a single button 132, but there may be more than one button) is configured to contact the respective side portion 130A, 130C of the U-shaped latch bar 130 (or indirectly contact via a tab, etc.). The biasing member(s) 134 therefore also biases the button 132 upwardly. Depressing the button(s) 132 causes the respective side portion 130A, 130C to move downwardly (e.g., rotate slightly), which downward motion is resisted by the at least one biasing member 134. As will be described below, sufficient movement of the side portions 130A, 130C of the U-shaped latch bar 130 downwardly causes the latch tab 136 extending outwardly from the respective side portion 130A, 130C to move substantially vertically) from an engaged position to a disengaged position.

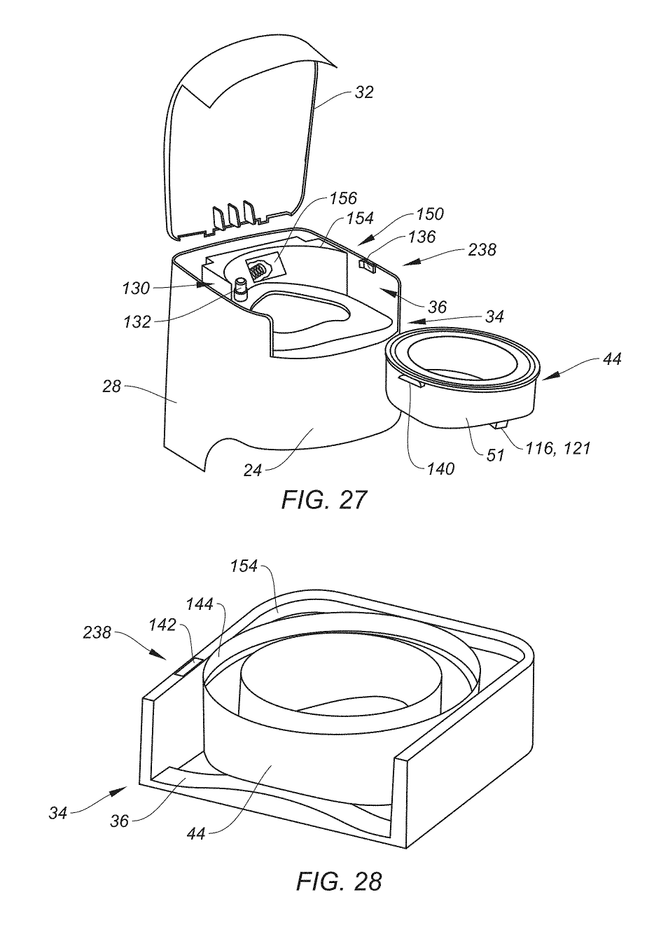

As can be seen in FIGS. 26 and 27, the cassette 44 includes a latch feature 140 extending out from (or disposed in) a side region of its outer wall 51 for each latch tab 136 of the U-shaped latch bar 130; e.g., in the embodiments shown in FIGS. 24-26, the U-shaped latch bar 130 includes opposing latch tabs 136 and the cassette 44 includes a mating latch feature 140 for each latch tab 136. The configuration of each latch feature 140 is such that when the cassette 44 is inserted into the cassette seat 36, the latch feature 140 pushes the latch tab 136 out of the way (e.g., downwardly to allow the latch feature 140 to move past the latch tab 136). Once the cassette 44 is inserted sufficiently into (or onto, or at least partially adjacent to) the cassette seat 36, the latch feature 140 is disposed beyond the latch tab 136 and the biasing member 134 forces the latch tab 136 back upwardly. As a result, the latch tab 136 is positioned to interfere with the latch feature 140 and thereby retain the cassette 44 within the cassette seat 36. The geometries of the latch tab 136 and the cassette 44 latch feature 140 are mating, but are not limited to any mating configuration. Examples of mating configurations are described above in terms of a latch member head portion 64 and a latch feature 140. The mating configurations of latch member head portion 64 and latch feature 104 are non-limiting examples of configurations that may be utilized with the latch tabs 136 and the latch features 140 in these front loading cassette 44 embodiments.

Latch feature 140 is generally L-shaped such that a portion of the “L” acts as a stop surface when engaged by latch tab 136. In the embodiments shown in FIGS. 26-27, the L shape describes at least one of the protruding portion of latch feature 140 and/or the recessed portion of latch feature 140. Latch feature 140 optionally has a first ramp surface and/or a second ramp surface, to assist with insertion, connection and/or at least partial ejection of the cassette 44 from waste disposal device 20.

FIGS. 26 and 27 show non-limiting examples of a cassette interface 36 and cassette 44 having a special rail 116 and channel 118 system. Cassette 44 has rail 116 on the aft portion of the cassette, such that rail 116 extends from the bottom portion 61, or furthermore at least one or both of the bottom surface 57 and/or aft region 65. The rail 116 acts as a rudder 121 and helps assist the cassette 44 during the loading process to ensure the cassette 44 is properly aligned with cassette interface 34. Rudder 121 can have a variety of shapes and configurations, and can include a first ramp surface and/or a second ramp surface (either/both as discussed throughout the present disclosure in other exemplary embodiments), and/or other configurations that are matingly received in a reciprocal feature in the cassette interface (perhaps on cassette seat 36).

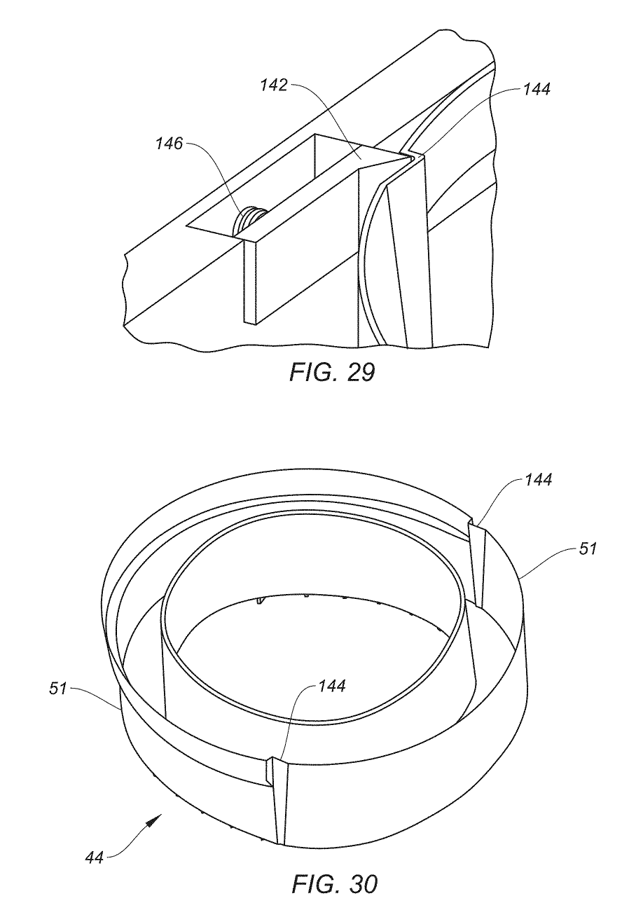

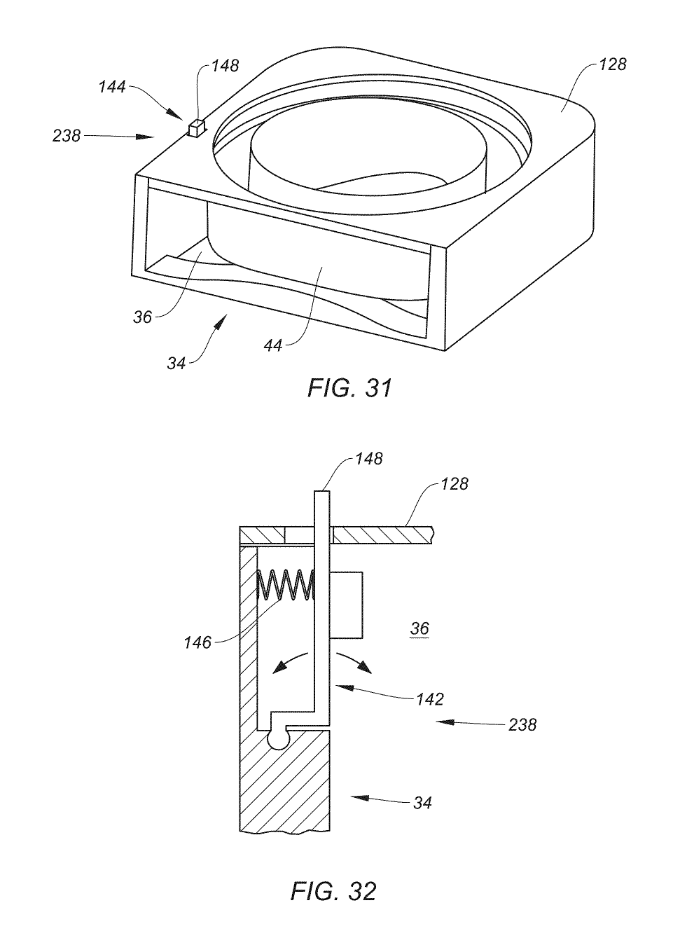

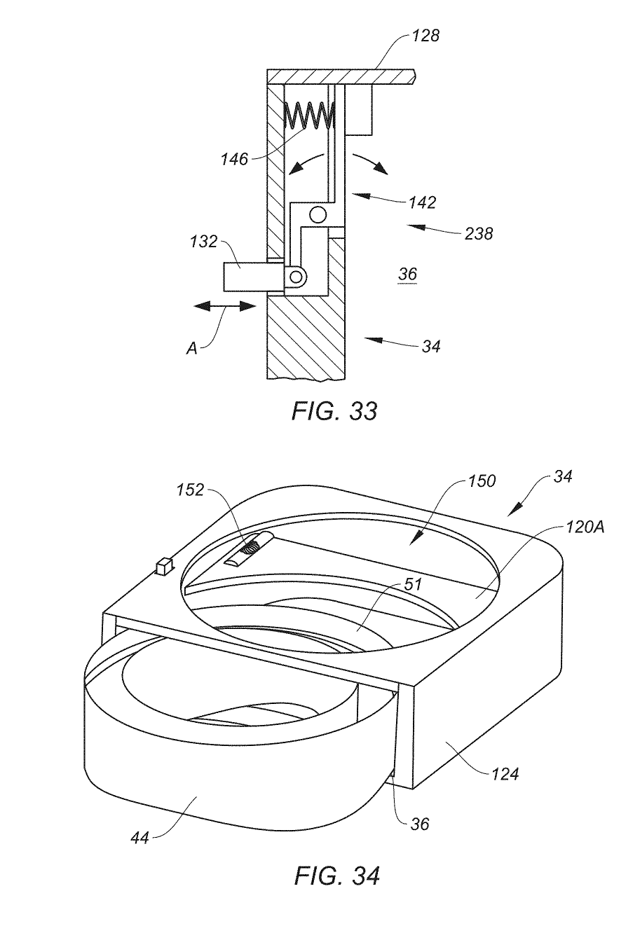

Other non-limiting examples of a latch mechanism 238 can be seen in FIGS. 28-31. In these embodiments, the latch mechanism 238 includes a latch tab 142 that is moved laterally relative to the cassette 44 to engage or disengage with a latch feature 144 disposed in or on the side region of the cassette outer wall 51. FIG. 28, for example, shows a diagrammatic depiction of a cassette 44 retained within a cassette seat 36 by a laterally movable latch tab 142. FIG. 29 is an enlarged view of the diagrammatically shown latch tab 142 shown in FIG. 28. The latch tab 142 is biased (e.g., by a spring 146) towards the center of the cassette seat 36, into engagement with the latch feature 144 of the cassette 44. FIG. 30 illustrates an example of a latch feature 144 disposed relative to the outer wall 51 of the cassette 44. FIGS. 31 and 32 diagrammatically show a latch mechanism 238 embodiment with a latch tab 142 having an arm 148 that extends outwardly above a top panel 128 of the cassette interface 34. The latch tab 142 is pivotally attached to the cassette interface 34. In the normal cassette engaged position (shown in FIG. 32, the latch tab 142 (and attached arm 148) are biased laterally towards an inner region of the cassette seat 36. Sufficient movement of the attached arm 148 laterally outwardly causes the latch tab 142 to move from the engaged position to a disengaged position, wherein the cassette 44 is no longer retained by the latch tab 142. FIG. 33 diagrammatically shows another latch mechanism 238 embodiment having a button 132 extending out from a side wall portion of the cassette interface 34. A biasing mechanism (e.g., a spring 146) normally biases the latch tab 142 in an engaged position. Sufficient movement of the button 132 (e.g., depressing the button in the direction of line “A”) causes the latch tab 142 to rotate from the engaged position to a disengaged position, wherein the cassette 44 is no longer retained by the latch tab 142.

Embodiments having top panel 128 provide certain advantages, namely the ability to load a cassette 44 into housing 22 with a single hand, and thereafter, dispense (i.e. pull) film upward from the cassette 44 while the cassette 44 is retained in the waste disposal device 20, thereby avoiding the need for two hand use during this interaction with the waste disposal device 20. Top panel 128, in some embodiments, can assist in metering film dispensed from cassette 44. Further still, top panel 128 can cooperate with certain cassette(s) 44 that do not have an upper surface 110 or cassette lid feature, or have a removable surface (i.e. shrink-wrap or overwrap) and thus need another means for containing and/or dispensing film from the cassette 44. Said differently, top panel 128 can act as an upper surface 110 and/or cassette lid. In some embodiments, top panel 128 can have a unique shape such that it functions similar to a funnel and helps direct waste into film (and thus the storage portion of the waste disposal device 20).

The latch mechanism 238 embodiments described above are merely examples of latch mechanisms and the present disclosure is not limited thereto; e.g., the latch mechanism could be operated by a button extending out of the top panel 128 of the cassette interface 34. In addition, as indicated above, the geometries of the latch tab 142 and the cassette latch feature 144 are mating, but are not limited to any mating configuration. Examples of mating configurations are described above in terms of a latch member head portion 64 and a latch feature 104. The mating configurations of latch member head portion 64 and latch feature 104 are non-limiting examples of configurations that may be utilized with the latch tabs 142 and the latch features 144 in these front loading cassette embodiments.

In some embodiments as exemplified in FIGS. 28-30, latch features 144 are generally L-shaped such that a portion of the “L” acts as a stop surface when engaged by latch tab 142. In the embodiments shown in FIGS. 26-27, the L shape describes the recessed portion of latch feature 144 and/or latch tab 142. Latch feature 144 and/or latch tab 142 optionally have a first ramp surface and/or a second ramp surface, to assist with insertion, connection and/or at least partial ejection of the cassette 44 from waste disposal device 20. In embodiments where both latch feature 144 and latch tab 142 have at least one ramp surface, the ramp surfaces may be complimentary and/or similarly angled and/or similar to any other described ramp angle discussed throughout the present disclosure.

In some embodiments, the cassette interface 34 may include a cassette biasing mechanism 150 disposed in or as part of the cassette seat 36 of the cassette interface 34. The cassette biasing mechanism 150 biases the cassette 44 outwardly in the direction toward the forward wall portion 24 of the waste disposal device 20 (e.g., see FIG. 18). For example, as a cassette 44 is inserted (in a generally horizontal direction when the waste disposal device 20 is in its normal operation position) into the cassette seat 36, the cassette biasing mechanism 150 will begin (at some point in the inward travel) resisting the insertion movement of the cassette 44. If the cassette 44 is inserted far enough into the cassette seat 36, the latch mechanism 238 (as described above) will begin to transition from an engaged position to a disengaged position to allow entry of the cassette 44. After sufficient inward movement of the cassette 44 into the cassette seat 36, the latch mechanism 238 will begin to transition from a disengaged position to an engaged position and thereafter be in a position to retain the cassette 44 within the cassette seat 36. When the cassette 44 is retained within the cassette seat 36, the cassette biasing mechanism 150 may bias the cassette 44 so that the cassette latch feature 144 is positively engaged with the respective latch tab 142.

An example of a cassette biasing mechanism 150 for a waste disposal device 20 having a front loading cassette is shown in FIG. 34. In this embodiment, the cassette biasing mechanism 150 includes a shelf portion 120A configured to receive a cassette 44 having flanges 124 that mate with the shelf 120A (e.g., see FIGS. 22 and 23 for an example of a flange 124 and shelf 120 arrangement). The shelf portion 120A is biased (e.g., by springs 152) toward the forward wall portion 24 of the waste disposal device 20 (i.e., towards a forward portion of the cassette interface 34). As the cassette 44 in inserted into the cassette seat 36, the flanges 124 disposed around at least a portion of the cassette 44 begin to mate with the shelf portion 120A, the outer wall 51 of the cassette 44 engages the shelf portion 120A. Further inward movement of the cassette 44 into the cassette seat 36 causes the shelf portion 120A to move inwardly with the cassette 44. The shelf portion biasing means (e.g., springs 152) resists but allows the cassette 44 to move towards at least a portion of the shelf (i.e. 120A, 120B, and/or any portion therebetween) and/or movement by the shelf (i.e. 120A, 120B and/or any portion there between), and in broader terms, permits engagement of the cassette 44 and the cassette interface 34. As indicated above, once the cassette 44 is inserted far enough into the cassette seat 36, the latch mechanism 238 will transition to an engaged position and thereafter retain the cassette 44 within the cassette seat 36 and the cassette biasing mechanism 150 will bias the cassette 44 so that the cassette latch feature 144 is positively engaged with the latch tab 142.

Another example of a cassette biasing mechanism 150 for a waste disposal device 20 having a front loading cassette is shown in FIG. 27. In this embodiment, the cassette seat 36 is partially defined by an aft wall portion 154 that is forwardly biased and configured to receive a cassette 44. The aft wall portion 154 is biased (e.g., by springs 156) toward the forward wall portion 24 of the waste disposal device 20 (i.e., towards a forward portion of the cassette interface 34). As the cassette 44 in inserted into the cassette seat 36, the outer wall 51 of the cassette 44 engages the aft wall portion 154, Further inward movement of the cassette 44 into the cassette seat 36 causes the aft wall portion 154 to move inwardly with the cassette 44. The aft wall portion 154 biasing means (e.g., springs 156) resists but allows the cassette 44 to move towards at least a portion of the shelf (i.e. 120A, 120B and/or any portion there between) and/or movement by the aft wall portion 154, and in broader terms, permits engagement of the cassette 44 and the cassette interface 34, As indicated above, once the cassette 44 is inserted far enough into the cassette seat 36, the latch mechanism 238 will transition to an engaged position and thereafter retain the cassette 44 within the cassette seat 36 and the cassette biasing mechanism 150 will bias the cassette 44 so that the cassette latch feature 140, 144 is positively engaged with the latch tab 136, 142.

In any of the above cassette biasing mechanism 150 embodiments for a device 20 with a front loading cassette 44, when the cassette 44 is to be replaced, the latch mechanism 238 is actuated, thereby causing the latch tab 136,142 to disengage with the cassette latch feature 140,144. Once the latch mechanism 238 is disengaged, the cassette biasing mechanism 150 will cause the cassette 44 to at least partially eject from the cassette seat 36. As a result, replacement of the cassette 44 from the device 20 is greatly facilitated.

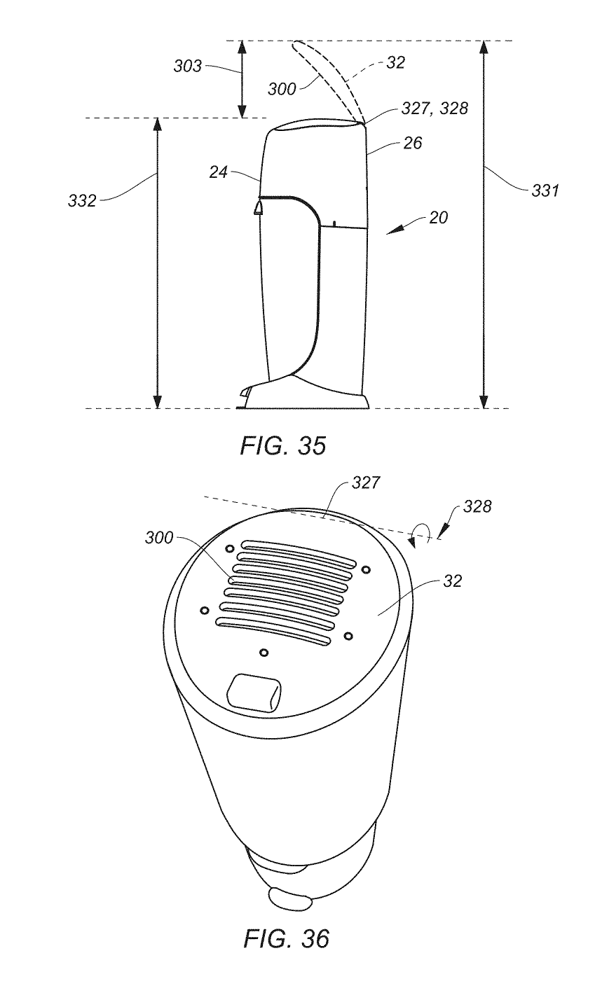

Referring to FIGS. 1 and 35, as described above embodiments of the waste disposal device 20 may include a lid 32 disposed in an upper portion 303 of the waste disposal device 20. The lid 32 embodiment shown in FIGS. 1 and 35 is pivotally attached to the upper portion 303 of the waste disposal device 20 (via one or more pivot axles 327 disposed on a pivot axis 328) proximate the aft wall portion 26 and is shown in its normally closed position. The lid can be rotated from the closed position to an open position by rotating the lid about a pivot axis 328 located proximate the aft wall portion 26. It can be seen from FIG. 35 that when the lid 32 is in an open position, a substantial portion of the lid 32 is disposed above where the lid 32 resided in its closed position.

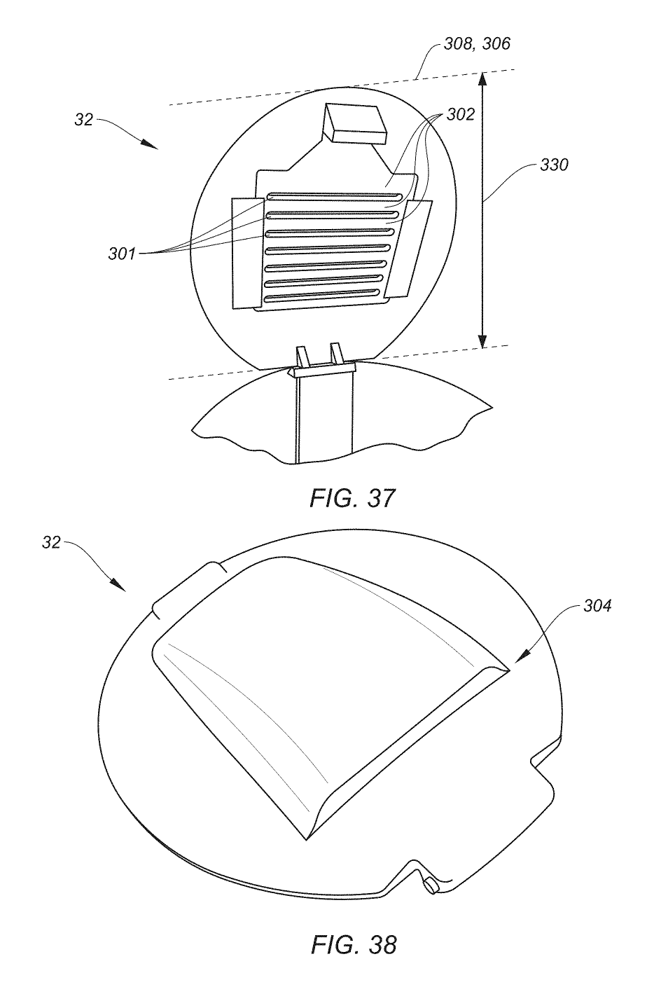

In some embodiments, a hinged lid 32 like that shown in FIGS. 1 and 35 may include one or more passages 300 that allow air to pass through the lid 32. For example, the embodiment shown in FIGS. 36 and 37 shows a lid 32 having a plurality of louvers 302 (but at least one louver 302), that allow air to pass through the lid 32 as the lid 32 is rotated between open and closed positions. The embodiment shown in FIG. 38 shows a lid 32 having a single passage 300 located adjacent the aft portion 304 of the lid 32. These embodiments are provided as examples of the present disclosure and are therefore non-limited lid 32 examples. In such examples having louvers 302 corresponding to one or more passages 300 allowing air to pass through the lid 32, the louvers 302 are optionally biased when the lid 32 is in a closed position. The louvers 302 are biased by a resilient mechanism 306 and a latch feature 308. When the lid 32 is in the closed position, the latch 308 is triggered, which triggers the resilient mechanism 306 to move the louvers 302 in a direction substantially aligned with the passages 300 (or holes 301 within or between the louvers 302). When the lid 32 is unlatched and moved to an open position, the resilient mechanism 306 is released and the louvers 302 move such that the passages 300 are open. Passages 300 and/or louvers 302 operate to mitigate disturbance of the air surrounding the upper portion 303 of the waste disposal device 20 such that wafting of any odorous air trapped within the waste disposal device 20 (between the lid 32 and the clamp 310) outward from the waste disposal device 20 and towards the general direction of the user is mitigated.

In embodiments such as those shown in FIGS. 1 and 35, a hinged lid 32 is designed to over-rotate (i.e. beyond about 90 degrees) when moving from the closed position to the opened position. This is advantageous in certain waste disposal devices 20 having a timing sequence between the lid 32 and clamp(s) 310, For clarity, clamp(s) 310 are a part of liner clamping system 354, as described throughout the present disclosure. For instance, depending on the relationship or linkage 342 between the lid 32 and clamp(s) 310, the lid's 32 ability to over-rotate allots for additional time for movement of the clamp(s) 310 between the closed clamp position and the open clamp position (and vice-versa). By allotting extra time via the lid's over-rotation, the clamp(s) 310 close before the lid 32 closes despite no further augmentation to the set-up of the waste disposal device 20 including the resiliency of biasing mechanisms on the lid 32 or the clamp 310. Alternatively, the lid's 32 opening beyond 90 degrees would permit increased time and enabling the clamp 310 to move between a clamp closed position and a clamp open position, or a first clamp closed position to an open position to a second clamp closed position. One skilled in the art will understand the present disclosure describes features that benefit from lid over-rotation and that assist in the mitigation of malodorous air escaping from waste products the liner in the waste disposal device 20.

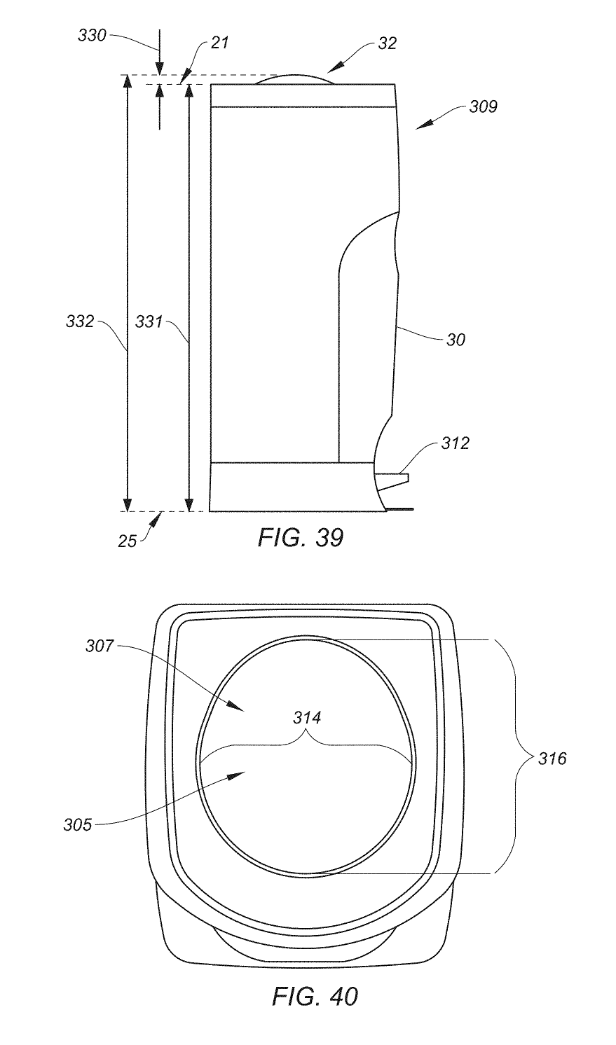

FIG. 39 provides an alternative embodiment to the lid 32 shown in FIGS. 1 and 35, the upper portion 303 of the waste disposal device 20 has an upper portion 303 that includes a contour 307. The contour can define any number of shapes in profile or in three-dimensions—arcuate, faceted, a quadrilateral or other prismatic shape, a conic or cylinder, etc. . . . , but namely defines the top 21 of the waste disposal device 20. The waste disposal device 20 includes lid 32 having a body 305 that translates back and forth along a path disposed within the contour 307 of the upper portion 303 of the waste disposal device 20 i.e., the lid body 305 translates in a first direction and an opposite second direction substantially within the contour 307 of the upper portion 303 of the waste disposal device 20. Because the lid body 305 translates back and forth along a path disposed within the contour 307 of the upper housing 309 of the waste disposal device 20, the maximum vertical height of the lid 32 does not increase when the lid 32 is in the open position, or when the lid 32 is translated between the closed and open positions (e.g., except perhaps for a small handle that may be present in a manually operating version). FIGS. 35 and 37 exemplify two embodiments with varying dimensions amongst the lid 32 and waste disposal device when the lid 32 is in open and closed configurations. For instance, FIG. 35 demonstrates the height 332 of waste disposal device 20 with the lid in the lid closed position, and the height 331 of the waste disposal device when the lid 32 is in the lid open position. FIG. 37 shows a different embodiment where the waste disposal height 332 when the lid is closed, and the height 331 of the waste disposal device 20 when the lid is open. As shown, distance 331 in FIG. 35 is greater than distance 332, (i.e. it adds height 332 and distance 330). As shown, distance 331 in FIG. 37 is less than distance 332, (i.e. it subtracts distance 330 from height 332). As exemplified in FIG. 44, the distance 336 of the lid 32 is determined from the uppermost point of the lid in either the closed or open position to the axis of rotation. If the lid 32 swings in a circular motion, this would be the length of the radius of the circle (or the arc, as it may be). Compare, for instance, the “added” height 331 to the waste disposal device 32 in view of maximum distance 330 (as exemplified in FIG. 35) versus the lack of additional distance 330 if looking at exemplary FIG. 39. In some embodiments, the waste disposal device 20 height 331 when the lid 32 is in the open position is less than or equal to the height 332 of the waste disposal device with the lid 32 in the closed position. In some embodiments, the waste disposal device 20 height 331 when the lid 32 is in the open position is less than the height 332 of the waste disposal device 20 with the lid 32 in the closed position. The path may be arcuate or linear, or some combination thereof. As will be described below, in some embodiments the lid body 305 may be a unitary structure, and in alternative embodiments the lid body 305 may include a plurality of elements, The lid 32 may be moved from the closed position to the open position either manually and/or by depressing a pedal 312 disposed on the bottom front of the waste disposal device 20.

The lid 32 moves from the closed position to the open position between 0 degrees and about 130 degrees, or less than about 130 degrees, less than about 120 degrees, less than about 110 degrees, or less than about 100 degrees. In other words, the lid 32 moves less than a half turn, less than or equal to about ⅜ of a turn when translating between the closed position and the open position. Depending on the configuration of the waste disposal device 20 and the relative geometry of the lid 32, the lid 32 moves such that it achieves an open position and a closed position (i.e. that fully cover the waste disposal device in the closed position and also do not inhibit the disposal of waste products in the open position). In other embodiments described throughout the present disclosure, the lid 32 includes a plurality of segments and such segments optionally move relative to other adjacent segments. As such, some individual segments of the lid 32 move far less than i.e., 130 degrees, while other individual segments of the lid 32 move closer to, i.e., up to about 130 degrees. In any event, the lid 32 is designed to rotate such that it does not interfere with the operation of the clamp(s) 310 or the clamping system 354, or impinging upon the storage capacity of the interior space 29. For instance, if the lid were rotate beyond 130 degrees, it is possible the lid would interfere with or otherwise impede the clamp and/or require additional space in the interior space 29, thereby reducing the capacity of waste the waste disposal device 20 holds prior to emptying.

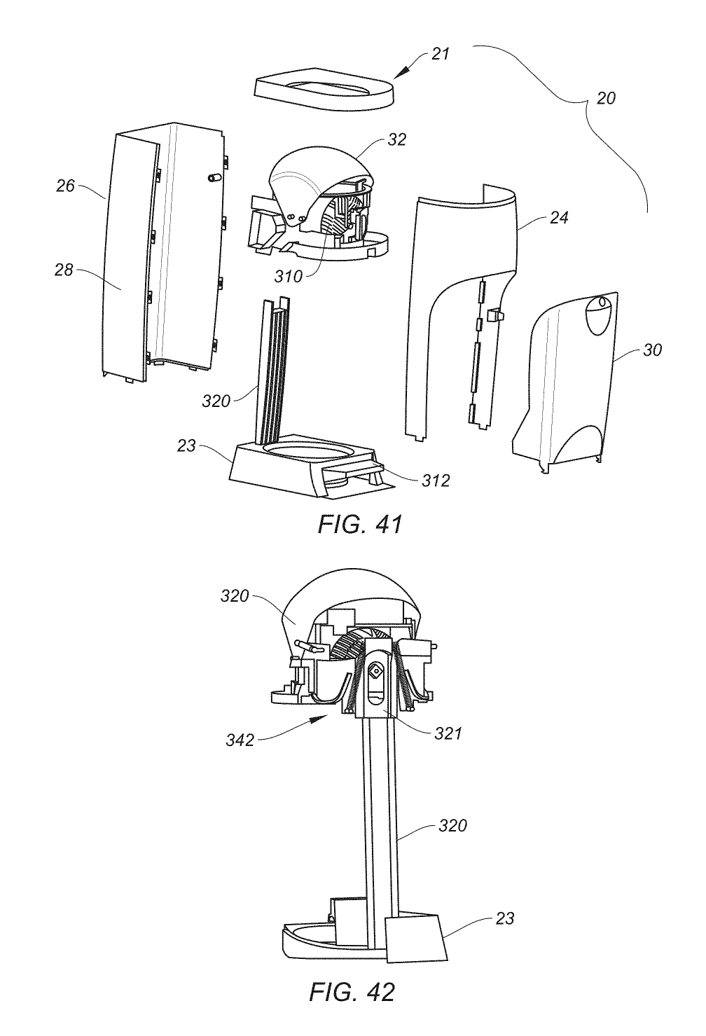

FIGS. 39-41 show a waste disposal device 20 having a lid body 305 embodiment that translates along an arcuate path. Hence, instead of the lid body 305 that pivots about an axis located proximate one end of the lid 32 (where the opposite end of the lid 32 rotates away from the waste disposal device 20 as shown in FIGS. 1 and 35), the lid body 305 travels along an arcuate path to expose or cover the interior space 29 of the waste disposal device 20. In this particular embodiment, the lid body 305 is a unitary structure having a widthwise curvature 314 and a lengthwise curvature 316, which curvatures combine to give the lid body 305 a scoop-like configuration. FIG. 41 is an exploded view of a waste disposal device 20 having a scoop-like lid 32 (shown in a closed position) that can be translated between a closed position and an open position by depressing a foot pedal 312. A linkage 342 (which includes a pushrod 320) connects the foot pedal 312 to the lid 32. Optionally, pushrod 320 includes a pushrod extension 321, as shown in FIGS. 42 and 46, amongst others.

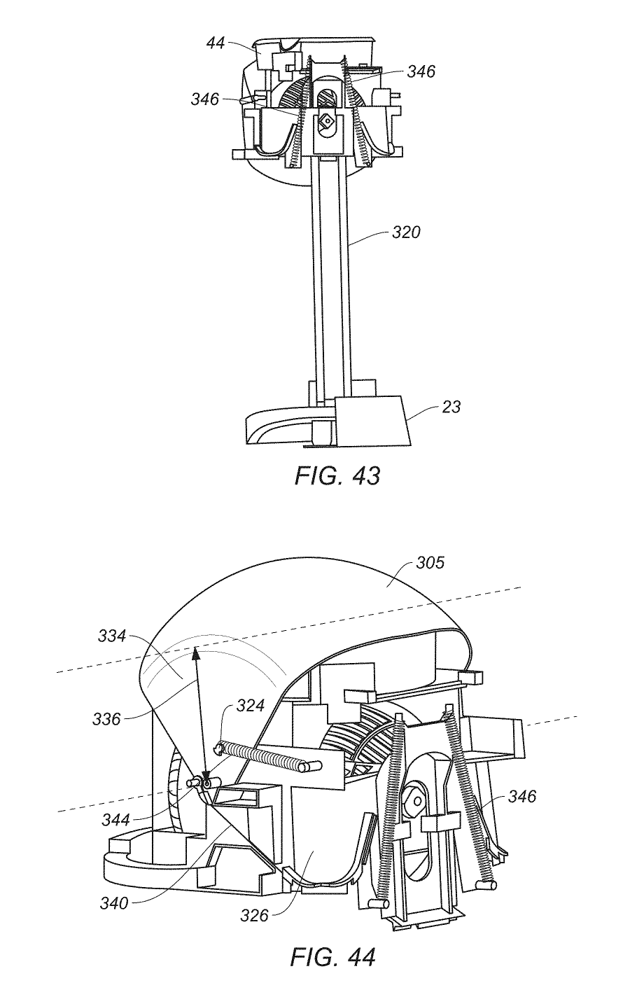

FIGS. 42 and 43 are diagrammatic partial views of a waste disposal device 20, showing an example of a linkage 342 that connects a foot pedal 312 to the lid 32. The linkage 342 includes a foot pedal 312, a pushrod 320. In some embodiments, the linkage 342 further includes a clamp actuator member 322. FIG. 42 shows the lid 32 in a closed position with the pushrod 320 biased downwardly, the foot pedal 312 biased upwardly. FIG. 43 shows the lid 32 in an open position with the pushrod 320 displaced upwardly and the foot pedal 312 depressed.

A variety of different mechanisms can be used to translate the lid 32 between the closed and open position, and to maintain the lid body 305 in a closed position. FIG. 44 (which shows a lid body 305 in a closed position), depicts an embodiment wherein a pair of side flanges 324 are attached to the lid body 305. The side flanges 324 are pivotally connected and/or mounted to a mounting structure 326 that mounts within the waste disposal device 20. The side flanges 324 (and attached lid body 305) pivot about a pivot axis 328. The lid body 305 therefore translates along an arcuate path defined by the distance 336 between the lid body 305 and the pivot axis 328 of the side panels 334. In this particular embodiment, when the mounting structure 326 is located within the waste disposal device 20, the pivot axis 328 is located below the top end 21 of the housing 22 of the waste disposal device 20, where the housing 22 of the waste disposal device 20 may or may not be inclusive of the entirety of the lid 32.

The lid body 305 is normally biased in a closed position, as shown in FIG. 44. In this particular non-limiting embodiment, a pair of lid springs 338 are used to bias the lid 32 in the closed position.

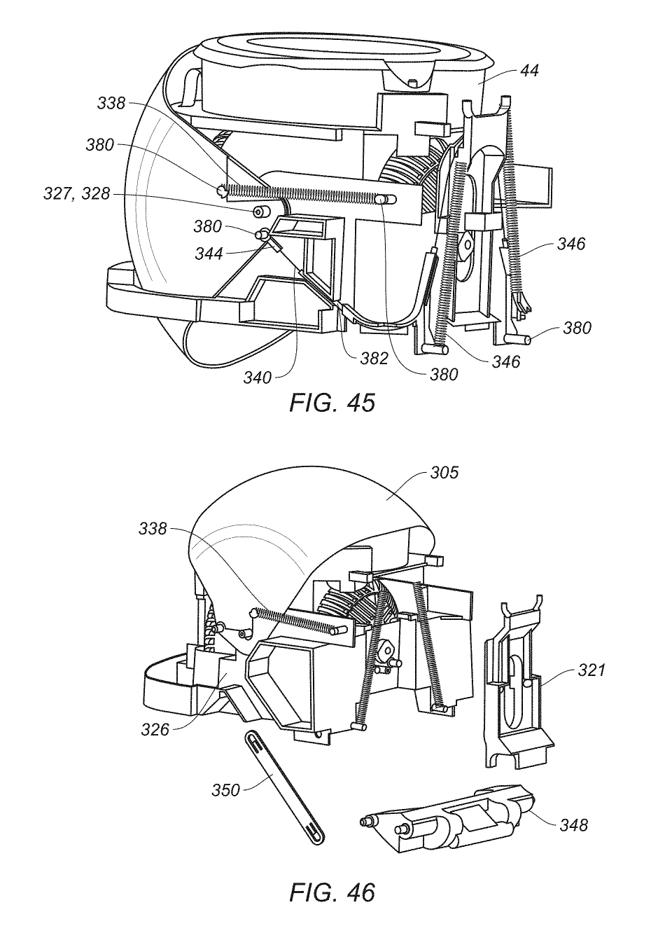

As indicated above, the embodiment shown in FIG. 39 is configured such that the lid 32 can be translated by depressing a foot pedal 312. In the particular embodiment shown in FIGS. 44 and 45, a cable 340 provides part of the linkage 342 between the foot pedal 312 and the lid 32. Specifically, one end 344 of the cable 340 is attached to one of the side flanges 324 and the other end 344 (not shown) of the cable 340 is attached to the other side flange 324. The cable 340 is also engaged with the pushrod 320, and the pushrod 320 is in communication with the foot pedal 312. A pair of pushrod springs 346 are used to bias the pushrod 320 downwardly, and the pushrod 320 (and other linkage 342 elements) in turn bias the foot pedal 312 in an upper position. Depressing the foot pedal 312 from the upper position to a lower position causes the pushrod 320 to translate upwardly. As the pushrod 320 translates upwardly, the cable 340 is draw upwardly. The ends 344 of the cable 340 attached to side flanges 324 cause the side flanges 324 and attached lid body 305 to rotate about the pivot axis 328, thereby translating the lid body 305 from the closed position to an open position (e.g., see FIG. 45). When the foot pedal 312 is released, the lid springs 338 acting directly on the lid 32 and the pushrod springs 346 acting on the pushrod 320 cause the lid body 305 to return to its normal closed position, the pushrod 320 to its normal downward position, and the foot pedal 312 to its normal upward position.

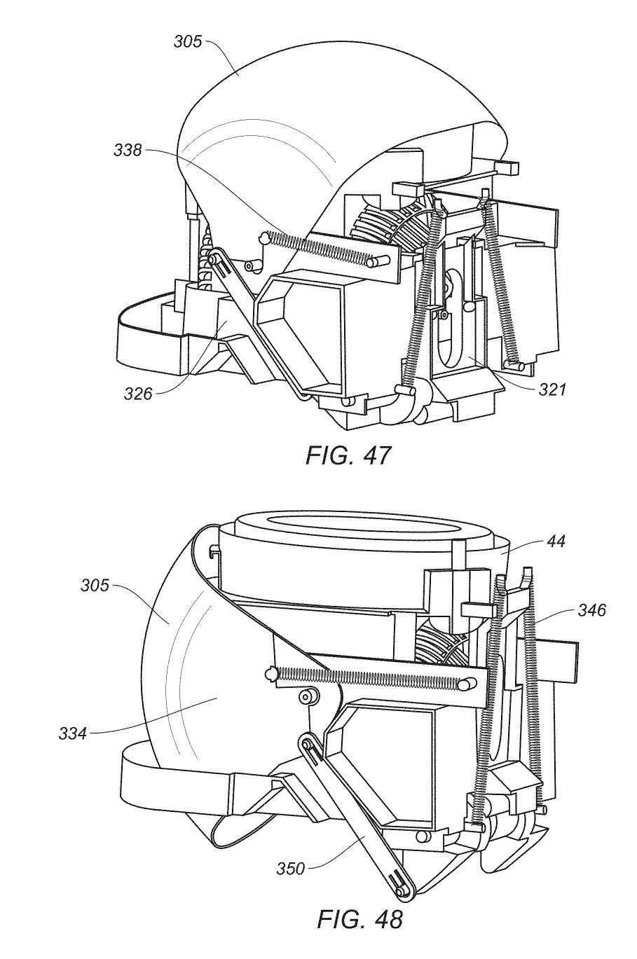

The above described linkage 342 including a cable 340 is a non-limiting example of a linkage 342 that can be used to actuate the lid 32. FIGS. 46-48 illustrate an alternative example having a linkage 342 that includes a cam 348 and a pair of link members 350. FIG. 47 shows an embodiment where the lid 32 is in the aforementioned closed position (i.e. to avoid confusion in describing the clamp 310 and its movement between open and closed, the lid in the closed position will now be referred to as the “lid closed position”), and FIG. 48 shows an embodiment with the lid 32 in an open position (i.e. to avoid confusion in describing the clamp 310 and its movement between open and closed, the lid in the open position will now be referred to as the “lid open position”). In both embodiments, the link members 350 are shown. The cam 348 is pivotally attached to the same mounting structure 326 (albeit, in certain embodiments, at a different location) that the lid is pivotally attached to, and is engaged with the pushrod. Each link member 350 is pivotally attached to a respective lid 32 side flange 324 and pivotally attached to the cam 348. Depressing the foot pedal 312 from the upper position to a lower position causes the pushrod 320 to translate upwardly (e.g., see FIG. 48). As the pushrod 320 translates upwardly, the cam 348 pivots. As the cam 348 pivots, the link members 350 are drawn downwardly and the lid 32 translates from the lid closed position to the lid open position. When the foot pedal 312 is released, the lid springs 338 acting directly on the lid 32 and the pushrod springs 346 acting on the pushrod 320 cause the lid body 305 to return to its lid closed position, the pushrod 320 to its normal downward position, and the foot pedal 312 to its normal upward position.

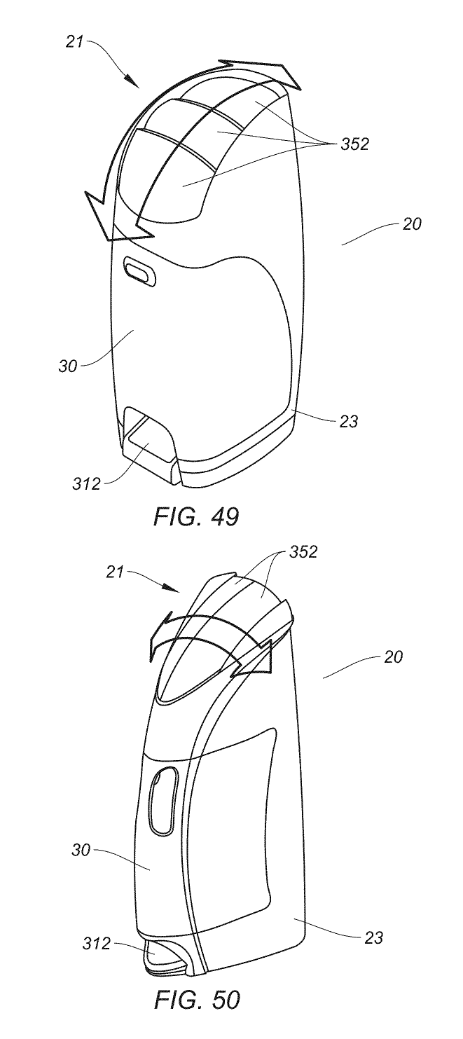

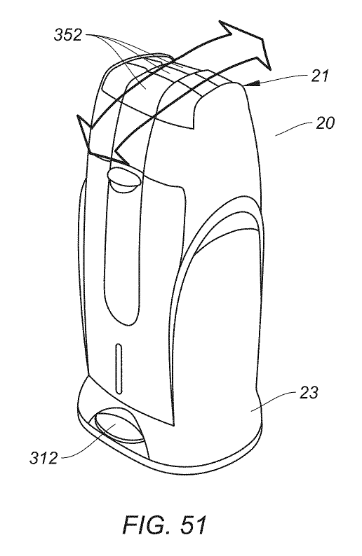

The examples provided above include a unitary lid 32. In other embodiments, the lid 32 may be comprised of a plurality of elements. For example, FIG. 49 illustrates an embodiment wherein the lid 32 (having a body that translates back and forth along a path disposed within the contour of the upper housing 309 of the waste disposal device 20) includes a plurality of lid elements 352 that nest with one another. In the lid closed position (shown in FIG. 49), the lid 32 elements extend over substantially all of the upper end of the waste disposal device 20 thereby creating a barrier (and optionally a seal) between the interior space 29 of the waste disposal device 20 and the surrounding environment. A portion of adjacent elements 352 overlap with one another. As the foot pedal 312 is depressed, the linkage 342 causes the elements 352 to move toward an end (i.e., front, back, or a side) of the waste disposal device 20, eventually being disposed in the lid open position wherein the lid elements 352 reside within a stacked configuration. FIG. 50 illustrates an embodiment wherein the lid 32 includes a pair of lid elements 352 that translate laterally back and forth along a path disposed within the contour 307 of the upper housing 309 of the waste disposal device 20. FIG. 50 illustrates this embodiment with the lid elements 352 in the lid closed position. As the foot pedal 312 is depressed, the linkage 342 causes each lid element 352 to move laterally outwardly to an open position where the interior space 29 of the waste disposal device 20 is exposed. FIG. 51 illustrates an embodiment wherein the lid 32 includes a pair of lid elements 352, including at least one that translates forward and at least one that translates aft, each along a path disposed within the contour 307 of the upper housing 309 of the waste disposal device 320. FIG. 51 illustrates this embodiment with the lid elements 352 in the lid closed position. As the foot pedal 312 is depressed, the linkage 342 causes at least one of the lid elements 352 to move forward and at least one of the lid elements 352 translates aft to an open position where the interior space 29 of the waste disposal device 20 is exposed. The above are non-limiting examples of a lid 32 that translates laterally back and forth along a path disposed within the contour 307 of the upper housing 309 of the waste disposal device 20.

In those embodiments described above wherein lid 32 follows a translation path (disposed within the contour 307 of the upper housing 309 of the waste disposal device 20) that includes an arcuate portion, the pivot axis (axes) 328 are located below the top 21 of the waste disposal device 20. In alternative embodiments, the lid 32 may follow a translation path having a pivot axis (axes) 328 that is located above the top 21 of the waste disposal device 20. In these embodiments, the lid 32 may include a unitary lid 32 or a plurality of lid elements 352.

Embodiments of the present disclosure lid 32 are described above as having a lid 32 that translates back and forth between the, for instance, forward wall portion 24 and aft wall portion 26 of the waste disposal device 20. In particular, some of the embodiments are described as having a lid 32 translation path wherein the lid 32 translates aftward to the lid open position and translates forward to the lid closed position. In alternative embodiments, the lid 32 may follow a translation path wherein the lid 32 translates aftward to the lid closed position and translates forward to the lid open position. Depending on the geometry of the lid 32, translating the lid 32 aftward to the lid closed position the waste disposal device 20 may provide a benefit of moving any malodorous air away from the user positioned near the front of the waste disposal device as the lid 32 closes.

An advantage of the present lid 32, including but not limited to the embodiments described above, is that during translation from the lid closed position to the lid open position, the lid 32 does not appreciably if at all draw air out of the interior of the waste disposal device 20. As a result, the chance that malodorous air will be moved in the direction of the user (positioned at the front, back or sides of waste disposal device 20) during use of the waste disposal device 20 is greatly diminished or eliminated. Testing to date suggests that the present lid 32 translating laterally back and forth along a path disposed within the contour 307 of the upper housing 309 of the waste disposal device 20 “cuts” or “slices” through the ambient air rather than creating a draw of air from the waste disposal device 20 interior space 29.

The examples provided above include a lid 32 that is actuated by a foot pedal 312. As indicated above, however, embodiments of the present disclosure include a lid 32 (having a lid body 305 that translates back and forth along a path disposed within the contour 307 of the upper housing 309 of the waste disposal device 20) that can be manually operated. In addition, the lid 32 embodiments described above can be used with a variety of different waste disposal devices 20, including those that use a single liner clamp and those that use more than one liner clamp.

As shown in 41-48, a waste disposal device 20 includes a lid 32 and a clamp 310. The clamp 310 and lid 32 move in a timing sequence driven by movement in linkage 342 including push rod 320. The timing sequence of the clamp 310 and the lid 32 is also dependent on the resilient and/or biasing mechanisms of the linkage 342. For instance, the waste disposal device 20 has lid springs 338, a cable 340, link members 350, and/or optionally pushrod springs 346 (for simplicity, these will be referred to as, individually or collectively, “lid biasing mechanisms”). These various lid biasing mechanisms individually or in combination provide varying resiliency profiles. Similarly, the clamp 310 has pushrod springs 346, and a cam system involving a cam actuator plate 362, cam pins 360 and slots 364 (for simplicity, these will be referred to as, individually or collectively, as “clamp biasing mechanisms”). These various clamp biasing mechanisms provide varying resiliency profiles.

In the embodiments shown in FIGS. 41-48, a foot pedal 312 is provided that enables the user to activate linkage 342 (including push rod 320) thereby driving movement of the clamp 310 and lid 32. In a simple system, the foot pedal 312 driving linkage 342 movement from the bottom-up, the clamp 310 typically moves with or slightly before the lid 32.

Systems utilizing cable 340 such as those shown in FIGS. 42-45, enable the lid 32 to move to the lid open position on a delay (i.e. after the clamp begins to move). Depending on the length of the cable 340 and the resiliency of the lid springs 338, the lid 32 will move to the lid. open position on a delay with respect to movement of the clamp(s) 310 and movement of the foot pedal 312 from its normal upward position. For instance, the cable 340 is designed to have slack (i.e. the length of the cable is longer than the length of the path the cable is aligned to via one or more posts 380 or tracks 382. The lid springs 338 are designed to have a spring force that permit a period of time to elapse between depressing the foot pedal 312 and movement of the lid 32. Said. differently, movement of the foot pedal 312 and/or push rod 320 do not equate to movement of the cable(i.e. due to the slack or extra length of the cable). Embodiments having a cable 340 with slack enable the delayed timing upon opening the lid 32, as the lid acts under tension. When the lid 32 is in the lid open position, the cable 340 is in tension, and will begin to return to the lid closed position when the foot pedal 312 is released (and duly begins to return to its normal upward position). With regard to a given side panel 334 of lid 32, the distances between the post 380 the lid spring 338 attaches to and the pivot axle 327 and between the post 380 the cable end 344 attaches to and the pivot axle 327 can be varied based on the correlation (or balancing of) the tension in the cable and the spring constant of the spring. As such, the distances can be greater or smaller, and optionally, the pivot axle 327, post 380 the cable end 344 attaches to, and/or the post 380 the lid spring 338 attaches to can be coterminous.

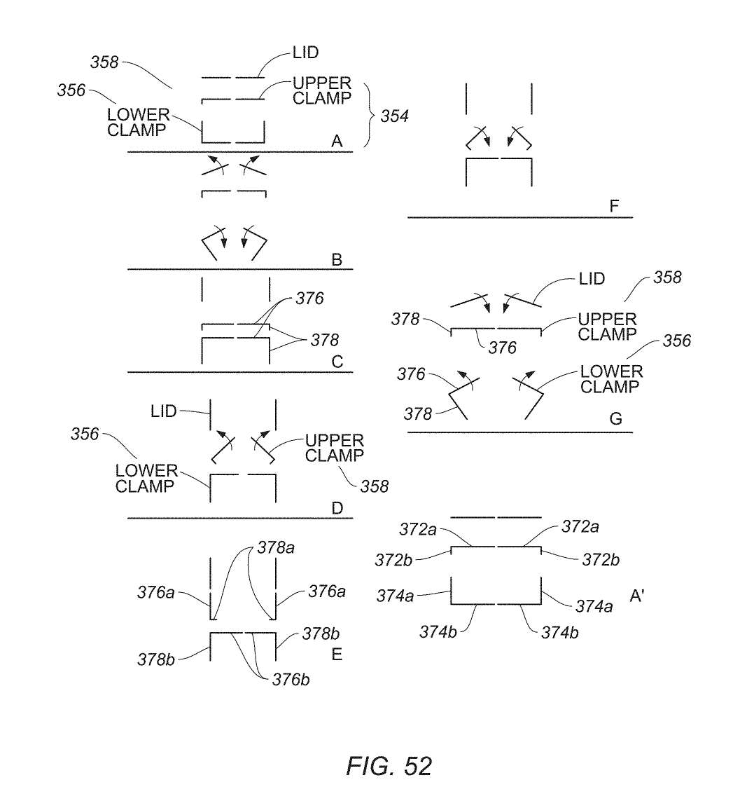

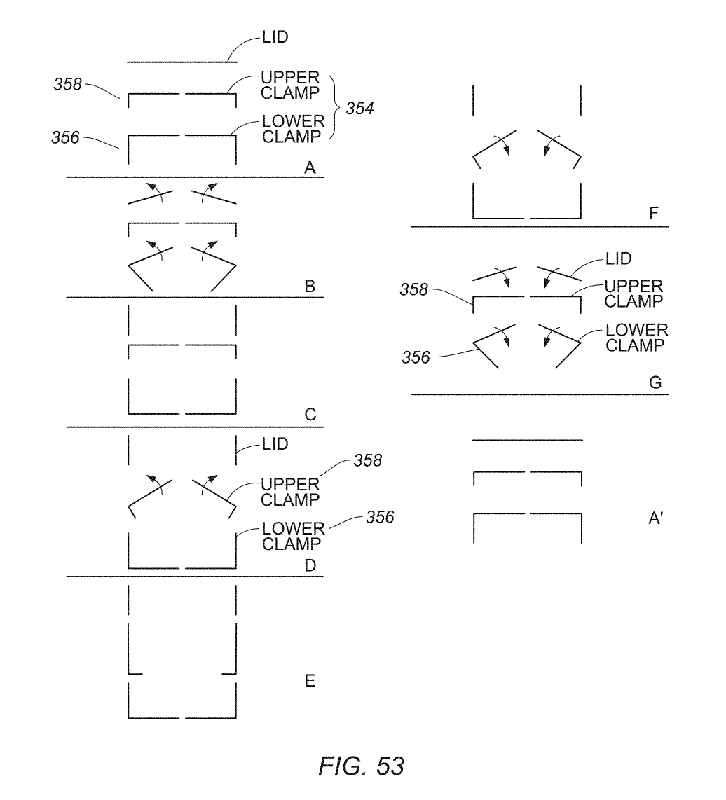

The clamp 310 can comprise one or more sections, pieces or members and duly have symmetry in a given plane and/or about an axis or plane (i.e., the X, Y or Z axis, and/or the X-Y, Y-Z and/or Y-Z planes), and can have symmetry in the clamp open position and/or the clamp closed position. The clamp can have symmetry about its pivot axis or pivot axes (in embodiments where portions of the clamp 310 move independently of each other). As exemplified in FIGS. 52-53, the clamp 310 has a first member 372 and a second member 374. Each or both of the first member 372 and second member 374 have an upper end 376 and a lower end 378. In certain embodiments such as those in U.S. Patent Application No. 2016/0229628 to Chakravarthy et al., the contents of which is incorporated by reference in its entirety, the upper end 376 and/or the lower end 378 of the first member 372 overlap with the corresponding end of the second member 374. In some embodiments such as those in U.S. patent Application No. 2015/0076153 to Rousso et al., the contents of which is incorporated by reference in its entirety, the upper end 376 and/or the lower end 378 of the first member 372 at least partially matingly engage the corresponding end of the second member 374. In any embodiment, the first member 372 and the second member 374, or the upper end 376 and/or the lower end 378 provide at least a partial seal of the liner such that the transmission of odorous air above the at least partial seal by the clamp 310 [due to any waste products within the liner below the clamp 310] is mitigated.

As described in FIG. 52, the first member 372 optionally has a first member upper clamp 372 and a first member lower clamp 372b. Likewise, the second member 374 has a second member upper clamp 374a and a second member lower clamp 374b. Similarly, the first member 372 has a first member upper end 376a and a first member lower end 378a, and optionally has two of such described members. Similarly, the second member 374 has a second member upper end 376b and a second member lower end 378b, and optionally has two of such described members. While such clamp(s) 310 in such liner clamping systems 354 are possible, one skilled in the art understands only a single clamp 310 structure is possible, or two such clamp(s) 310.

The first member 372 and second member 374 can be similar and duly complement each other (i.e. to mate with each other and/or overlap/intersect when forming an at least partial seal of the liner, or such that they can avoid each other as they move between open and closed positions). In some embodiments, the first member 372 and second member 374 are congruent such that they are interchangeable parts.

In other embodiments, the clamp comprises a structure similar to a funnel or a cone, or a diaphragm; these structures can be suitably shaped to help direct waste products into the liner (i.e. to supplement gravitational forces pulling the waste products downward into the liner). In such embodiments, the clamp may have a number of undulating or flexible portions acting as resilient fingers to help grab the liner to create at least a partial seal while also permitting the clamp to deflect and permit disposal of waste products into the liner below the clamp. In some such embodiments, the funnel, cone or diaphragm is moveable in the X-Y plane via rotation about a central vertical axis (i.e., the Z-axis) causing the liner to twist in the X-Y plane. In other embodiments, the funnel, cone or diaphragm is moveable in the X-Z and/or Y-Z plane via rotation about a central horizontal axis (i.e. the X or Y axis), causing the liner to fold onto itself and create a bend (i.e. at least a partial seal).

According to another aspect of the present disclosure, a liner clamping system 354 is provided that includes a lower liner clamp(s) 356 and an upper liner clamp(s) 358. The liner clamp system 354 includes a plurality of different embodiments. In all of these embodiments, the opening and closing of the liner clamp(s) (i.e., lower liner clamp 356 and upper liner clamp 358) are operationally timed relative to one another, and may be actuated by the foot pedal 312 and associated linkage 342. The operational timing of the opening and closing of the lower liner clamp(s) 356 and upper liner clamp(s) 358 and the opening and closing of the lid 32 are coordinated relative to one another in a manner that mitigates or eliminates the propagation of malodorous air from the interior space 29 of the waste disposal device 20 outwardly where it may be sensed by the user. In some embodiments, the operation of the upper liner clamp(s) 358 may be timed so that the upper liner clamp(s) close(s) after the lid 32 closes to mitigate or prevent any outward propagation of malodorous air from the interior space 29 of the waste disposal device 20.

The operational timing of the waste disposal device 20 may be described in terms of static conditions and transitional phases. In an “at rest” condition, the foot pedal 312 and the liner clamping system 354 are in a normal at rest position; i.e., the foot pedal 312 is in its normal upward position and at least one of the clamps (i.e., lower liner clamp(s) 356 and upper liner clamp(s) 358) is positioned to pinch the liner (not shown) closed. In an “opening phase”, the foot pedal 312 is being depressed and traveling from its normal upward position to a fully depressed position. During at least a part of this “opening phase”, the lid 32 is being translated from a lid closed position to a lid open position. In an “open” condition, the foot pedal 312 is maintained completely depressed and the lid 32 is maintained in the lid open position. In a “closing phase”, the foot pedal 312 is released and travels from its fully depressed position back to its normal upward position. During at least a portion of the “closing phase”, the lid 32 is translating back to its lid closed position. Once the foot pedal 312 returns to its normal upward position, the liner clamping system 354 and the lid 32 are returned to the “at rest” condition.

In some embodiments when the waste disposal device is in the “at rest” condition, only one of the lower liner clamp(s) 356 and upper liner clamp(s) 358 is positioned in a clamp closed position; i.e., in a position wherein the clamp pinches or otherwise manipulates the liner to close the opening of the liner that allows entry of waste products into the liner. Preferably, however, in the “at rest” condition, the clamps in the liner clamping system 354 are in the clamp closed position, or as described in some embodiments, both of the lower liner clamp(s) 356 and upper liner clamp(s) 358 are in the clamp closed position.

In some embodiments, the operational timing of the lower liner clamp(s) 356 and upper liner clamp(s) 358 is such that one of the clamps is closed while the other is opened, or the amount of time that both clamps are to some degree open is reduced. Maintaining at least one of the clamps closed when the lid 32 is in the lid closed position helps to mitigate the propagation of malodorous air from the storage portion of the liner (i.e. the portion of the liner within the storage portion of the waste disposal device 20 that is below the clamp 310, and/or in embodiments having upper liner clamp(s) 358 and lower liner clamp(s) 356, below the lower liner clamp(s) 356 and optionally the upper liner clamp(s) 358) into the “new waste” receiving portion of the waste disposal device 20 (i.e. the portion of the waste disposal device 20 between the lid 32 and the clamp 310, or in embodiments having upper liner clamp(s) 358 and lower liner clamp(s) 356, the portion between the lid 32 and the upper liner clamp(s) 358 and optionally the lower liner clamp(s) 356), which in turn mitigates the amount of malodorous air that may potentially be propagated out of the waste disposal device 20.

An example of an operational timing that may be assumed by the waste disposal device 20 is shown in FIG. 52. When the waste disposal device 20 is in an “at rest” configuration (identified as “A” in the sequence shown in FIG. 52), both clamps are in the clamp closed position and the lid 32 is in the lid closed position. When the user begins to depress the foot pedal 312 (i.e., an initial portion of the “opening phase”; shown as “B”, “C”, and “D in the sequence shown in FIG. 52), the lower liner clamp(s) 356 begin(s) to transition from a first closed configuration, through an open configuration, to a second closed configuration. At the same time the lower liner clamp(s) 356 is transitioning from the first closed configuration to the second closed configuration, the lid 32 is opening, and the upper liner clamp(s) 358 remain(s) in the clamp closed position. As the user continues to depress the foot pedal 312, the lower liner clamp(s) 356 reach(es) the second closed configuration, and the lid 32 reaches its lid open position. At this point, the foot pedal 312 is not yet fully depressed; i.e., the waste disposal device 20 is still in the opening phase. As the user continues to depress the foot pedal 312, the upper clamp opens. When the upper liner clamp(s) 358 is fully open, the lid 32 is fully open, and the lower liner clamp(s) 356 is in its second closed configuration, the “opening phase” is completed and the waste disposal device 20 has transitioned to an “open” condition (shown as “E” in the sequence shown in FIG. 52). If the foot pedal 312 is maintained completely depressed, the waste disposal device 20 will remain in an open condition. When the waste disposal device 20 is in the open condition, waste product may be deposited within the waste disposal device 20. Note that in the open condition, the lower liner clamp(s) 356 prevents the deposited waste product from traveling to the bottom of the liner, and the contents within bottom of the liner are closed off by the lower liner clamp(s) 356. Once the user releases the foot pedal 312 from the completely depressed position, the closing phase (“F” and “G” in the sequence shown in FIG. 52) is initiated and the upper liner clamp(s) 358 closes (e.g., see “F”). Once the upper liner clamp(s) 358 is closed (and the foot pedal 312 continues to transition to its normal upwardly biased position), the lid 32 begins to close and at the same time the lower liner clamp(s) 356 transitions from its second closed position, through the open configuration, and back to its first closed condition (e.g., see “G”). During the lower liner clamps) 356 open configuration (which occurs as the lower liner clamp(s) 356 transitions from its second closed position back to its first closed condition), waste product deposited into the waste disposal device 20 is allowed to pass through to the bottom of the liner. At, or about, the point when the lower liner clamp(s) 356 is in its first closed configuration, the lid 32 is completely closed, and the foot pedal 312 is returned to its normal upwardly biased position. Hence, the waste disposal device 20 is returned to its “at rest” condition (shown as “A”).

FIG. 53 shows an operational timing sequence similar to that shown in FIG. 52. In FIG. 53, the lower liner clamp(s) 356 assumes a different configuration. As a indicated above, both FIGS. 52 and 53 are diagrammatic representations intended only to facilitate an understanding of an exemplary operational timing sequence and are not intended to be limiting in any way, including any limitation with respect to the liner clamping system 354 or lid 32 configurations. For example, the timing sequence may also be such that the upper liner clamp(s) 358 opens before the lower liner clamp(s) 356. The upper liner clamp(s) 358 may open after the lid 32 opens (via depression of the foot pedal 312) and/or prior to a change in position of the lower liner clamp(s) 356 (i.e. from a first state to a second state, or from a closed position to an open position, or an open position to a closed position). In some embodiments, the lid 32 may open, the upper liner clamp(s) 356 opens in parallel or series, and the lower liner clamp(s) 358 remains substantially static. Upon release of the foot pedal 312, the lid 32 closes and the upper liner clamp(s) 358 may move towards a close position in parallel or in series with the lid 32. The lower liner clamp(s) 356 may move from a first position to a second position (i.e. from a first closed position to a second closed position, or from a closed position to an open position) in parallel or in series with one or both of the lid 20 and upper liner clamp(s) 358. In some embodiments, the movement of the lower liner clamp(s) 356 occurs at least partially in series with the lid 32 and/or upper liner clamp(s) 358 such that as a clamp closes (forming a barrier between the waste and the lid 32) prior to the other of the clamps permitting a passage to the waste in the waste disposal device 20.

Another example of an operational timing that may be assumed by the waste disposal device 20 is described below. When the waste disposal device 20 is in an “at rest” configuration, the liner clamping system 354 (i.e. both lower liner clamp(s) 356 and upper liner clamp(s) 358) are closed and the lid 32 is closed. When the user begins to depress the foot pedal 312 (i.e., an initial portion of the “opening phase”), the lower liner clamp begins to transition from a first closed configuration, through an open configuration, to a second closed configuration. At the same time the lower liner clamp(s) 356 is transitioning from the first closed configuration to the second closed configuration, the lid 32 is opening, and the upper liner clamp(s) 358 remains closed. As the user continues to depress the foot pedal 312, the lower liner clamp(s) 356 reaches the second closed configuration, and the lid 32 reaches its fully open position. At this point, the foot pedal 312 is not yet fully depressed; i.e., the waste disposal device 20 is still in the opening phase. As the user continues to depress the foot pedal 312, the upper liner clamp(s) 358 opens. When the upper liner clamp(s) 358 is fully open, the lid 32 is fully open, and the lower liner clamp(s) is in its second closed configuration, the “opening phase” is completed and the waste disposal device 20 has transitioned to an “open” condition. If the foot pedal 312 is maintained completely depressed, the waste disposal device 20 will remain in an open condition. When the waste disposal device 20 is in the open condition, waste product may be deposited within the waste disposal device 20. Note that in the open condition, the lower liner clamp(s) 356 prevents the deposited waste product from traveling to the bottom of the liner, and the contents within bottom of the liner are closed off by the lower liner clamp(s) 356.

Once the user releases the foot pedal 312 from the completely depressed position, the closing phase is initiated. In this operational timing sequence embodiment, the lid 32 closes before the upper liner clamp(s) 358 closes. For example, the lid 32 closes and the upper liner clamp 358 subsequently closes. Once the upper liner clamp(s) 358 closes, the lower liner clamp(s) 356 transitions from its second closed configuration back to its first closed configuration such that at least the closed configuration occurs after the upper liner clamp(s) 358 closes. An advantage of this operational timing sequence is that the lid 32 is closed prior to the upper liner clamp(s) closing (at the same time the lower liner clamp(s) 356 is held in its second closed configuration). Hence, any malodorous air disturbance that may be caused by the second liner damp(s) 358 closing is maintained within the waste disposal device 20 by the closed lid 32.

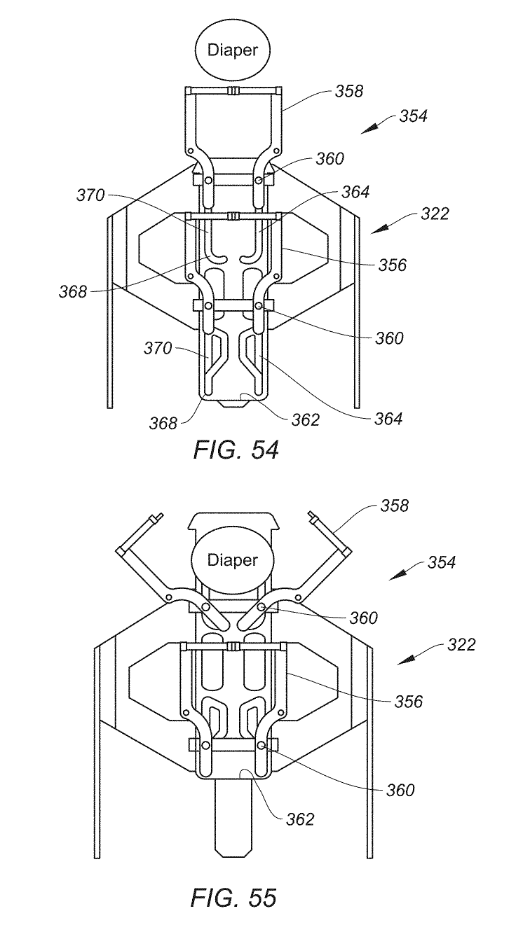

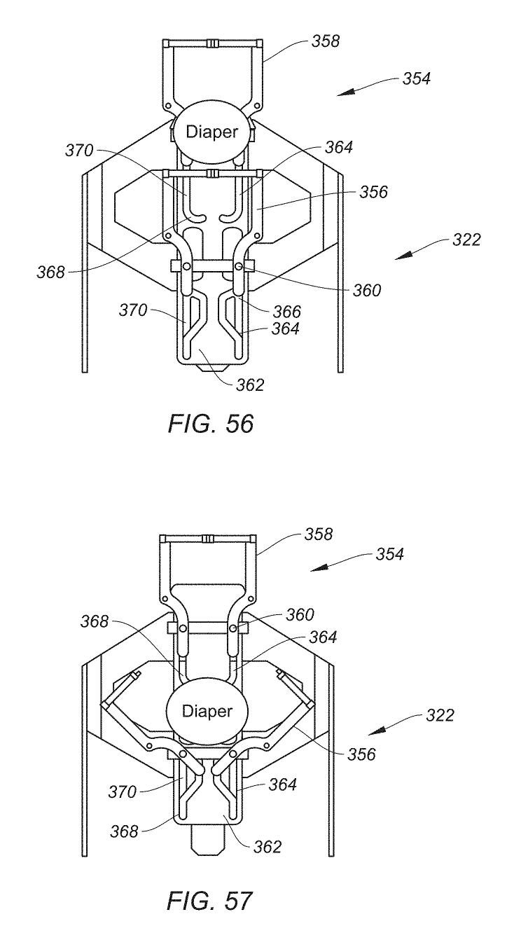

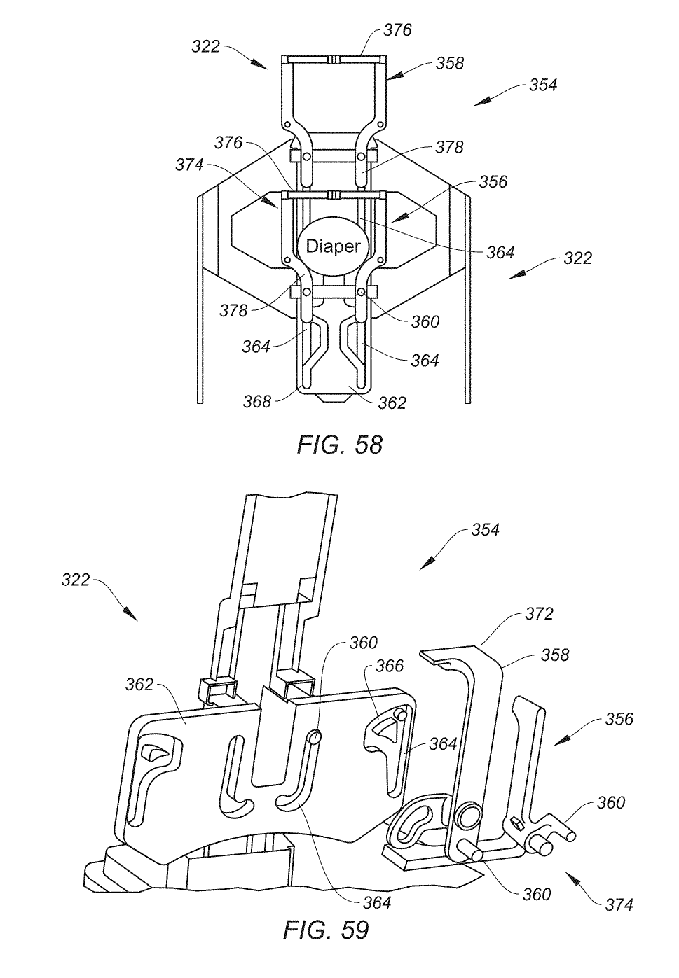

FIGS. 54-58 diagrammatically illustrate yet another operational timing sequence embodiment for a liner clamping system 354 having an arrangement including lower liner clamp(s) 356 and an upper liner clamp(s) 358.

It should be understood that the above described operation of a liner clamping system 354 having an arrangement including lower liner clamps) 356 and an upper liner clamp(s) 358 and the lid 32 is not strictly limited to its absolute terms. For example, the present disclosure contemplates that there may be some relatively minor overlap of one or more clamps in the liner clamping system 354 and lid 32 opening and closing functions.

The above described operational timing sequences may be accomplished by a variety of different a liner clamping system 354 having an arrangement including lower liner clamp(s) 356 and an upper liner clamp(s) 358, and the present disclosure is not, therefore, limited to particular liner clamping system 354 configurations. FIGS. 59-63 illustrate a non-limiting example of a lower liner clamp(s) 356 and an upper liner clamp(s) and how they may be actuated.

FIGS. 59-63 show exploded partial views of a linkage 342 and liner clamping system 354, including a push rod 320, a clamp actuator member, a portion of a lower liner clamp 356, and a portion of an upper liner clamp 358. As described above in the context of the lid 32, when the foot pedal 312 is depressed, the linkage 342 actuates the pushrod 320 upwardly from its normal biased position. As the pushrod 320 translates upwardly, the clamp actuator mechanism 322 which is attached or otherwise engaged with the pushrod 320 also translates upwardly. The lower liner clamp(s) 356 and upper liner clamp(s) 358 are engaged with the clamp actuator mechanism 322. Consequently, translation of the clamp actuator mechanism 322 causes the lower liner clamp(s) 356 and upper liner clamp(s) 358 to actuate. The present disclosure is not limited to any particular engagement between the clamp actuator mechanism 322 and the liner clamping system 354. The liner clamping system 354 are shown in partial view in FIGS. 59-63 to avoid obscuring the claim actuator mechanism 322, thereby facilitating the description below.

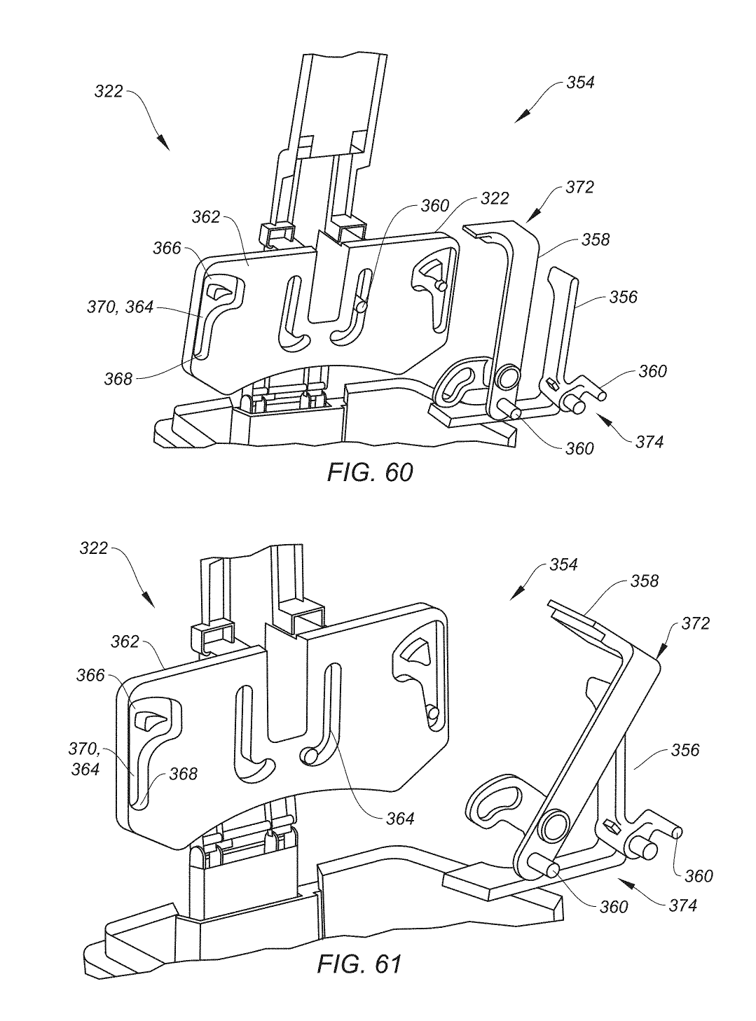

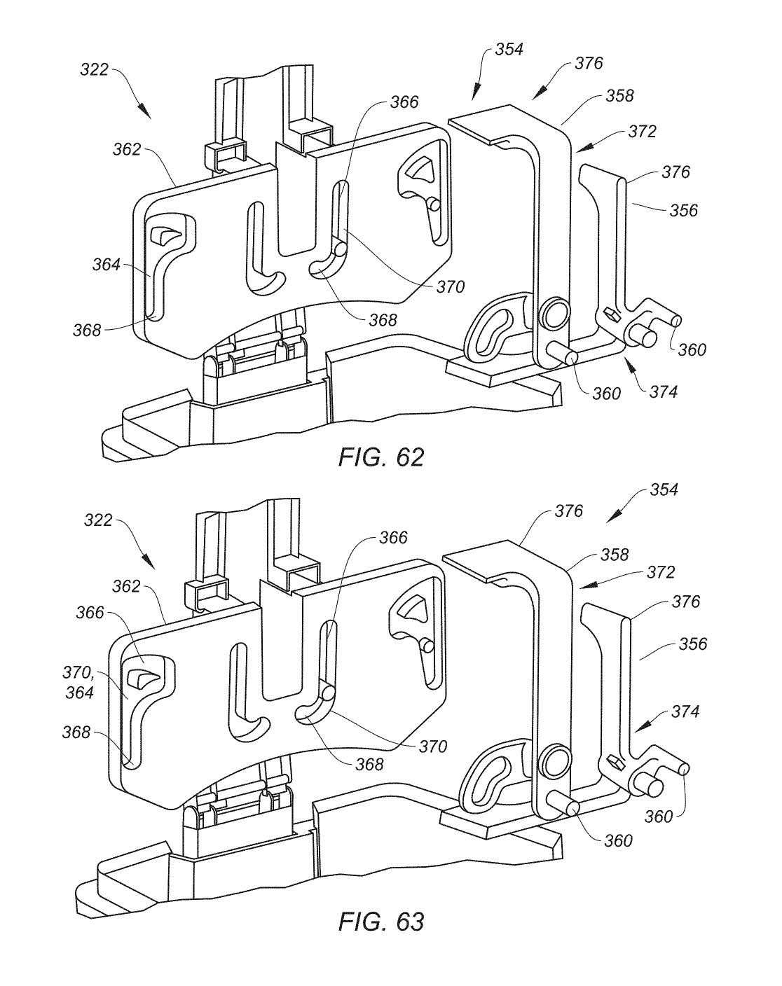

As an example, as can be seen in FIGS. 59-63, the lower liner clamp(s) 356 and upper liner clamp(s) 358 are pivotally mounted and include cam pins 360 that are received within respective slots formed in the clamp actuator mechanism 322. The slots dictate the movement and timing of the upper liner clamp(s) 356 and upper liner clamp(s) 358. In FIG. 59, the upper liner clamp(s) 356 and upper liner clamp(s) 358, pushrod 320 and clamp actuator plate 362 are shown in the “at rest” position; i.e., the upper liner clamp(s) 358 is in a closed position and the lower liner clamp(s) 356 is in a first closed position. The respective cam pins 360 of the lower liner clamp(s) 356 and upper liner clamp(s) 358 are shown not only on the clamps 310, but also received within the slots 364 to facilitate the description. As can be seen in FIG. 59, the respective cam pins 360 are located toward the upper portion 366 of the respective slots 364. FIG. 60 shows the pushrod 320 and clamp actuator mechanism 322 translated upwardly relative to the position shown in FIG. 59. In FIG. 60, the respective cam pins 360 are located midway in the respective slots 364, with the upper liner clamp(s) 358 still in a closed position and the lower liner clamp(s) 356 still in the first closed position. FIG. 61 shows the pushrod 320 and clamp actuator mechanism 322 translated upwardly relative to the position shown in FIG. 60. In FIG. 61, the respective cam pins 360 are located at a lower end 368 of the respective slots 364, with the upper liner clamp(s) 358 now actuated into an open position and the lower liner clamp(s) 356 still in the first closed position. FIG. 61 illustrates the lower liner clamp(s) 356 and upper liner clamp(s) 358 in a static position where the foot pedal 312 is completely depressed. FIG. 62 shows the pushrod 320 and clamp actuator mechanism 322 now translated downwardly relative to the position shown in FIG. 61. In FIG. 62, the respective cam pins 360 are located slightly above midway in the middle portion 370 in the respective slots 364. The upper liner clamp(s) 358 has returned to a closed position. Note that the cam pin 360 for the lower liner clamp(s) 356 is received within a portion of its slot 364 that was not traveled in during the opening process, but rather is in a slot 364 that has caused the lower liner clamp(s) 356 to move to a second closed position. Any waste deposited in the waste disposal device 2.0 when the waste disposal device 20 was held fully open has been dropped into the storage portion of the liner below the liner clamping system 354 as the lower liner clamp(s) 356 transitioned between the first closed position to the second dosed position. FIG. 63 shows the liner clamping system 354, push rod 320, and clamp actuator mechanism 322 returned to its initial “at rest” position. Hence, it can be seen from the above that the actuation timing of the lower liner clamp(s) 356 and upper liner clamp(s) 358 is dictated by the travel of their respective cam pins 360 within the slots 364 disposed within the clamp actuator mechanism 322.

The present disclosure is not limited to any particular lower or upper clamp geometry; e.g., the upper clamp members may be somewhat flat and straight and the lower clamp members may be “L” shaped and/or curved. Each clamp member may be described as having leading end and a trailing end, where either or both can form a seal (i.e. pinch closure) with the liner disposed there between. The clamp members may mate with one another at both leading and trailing ends, or they may nest/overlap to form seals at the upper and closed ends, or some combination thereof.

In this document, the terms “a” or “an” are used, as is common in patent documents, to include one or more than one. In this document, the term “or” is used to refer to a nonexclusive or, unless otherwise indicated. It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc., as they may be included, are used merely as labels, and are not intended to impose numerical requirements on their objects. In the Detailed Description provided above, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A waste disposal device comprising:
a liner material for holding waste;
a housing having a receiving portion for retaining the liner material, and a storage portion for holding waste within the liner material, the housing having a height defined by a bottom end and a top end;
a movable clamp creating at least a partial seal of the liner material, the clamp separating the receiving portion and the storage portion of the housing; and
a lid that that translates back and forth along a path disposed within the contour of the upper portion of the waste disposal device, the lid having a pivot axis located below the below the top end of the waste disposal device;
wherein the lid translates between a closed position and an open position; and
wherein the translation of the lid does not impede the movable clamps ability to create at least a partial seal of the liner material.

2. The waste disposal device according to claim 1, wherein the translation of the lid does not impinge upon the storage capacity of the interior space 29.

3. The waste disposal device according to claim 1, wherein the translation of the lid is less than 130 degrees.

4. The waste disposal device according to claim 3, wherein the translation of the lid is less than about 110 degrees.

5. The waste disposal device according to claim 1, wherein a height of the waste disposal device does not increase when the lid is in the open position.

6. The waste disposal device according to claim 1, wherein the height of the waste disposal device decreases when the lid is in the open position.

7. The waste disposal device according to claim 1, where the translation of the lid is a slicing motion.

8. The waste disposal device according to claim 1, further comprising a linkage that assists the lid's translation.

9. The waste disposal device according to claim 8, wherein the linkage includes a cable.

10. The waste disposal device according to claim 8, wherein the linkage includes at least one lid spring.

11. The waste disposal device according to claim 8, wherein the linkage assists the movable clamp's creating of an at least partial seal of the liner material.

12. A waste disposal device comprising:
a liner material for holding waste;
a housing having a receiving portion for retaining the liner material, and a storage portion for holding waste within the liner material, the housing having a height defined by a bottom end and a top end;
a movable clamp creating at least a partial seal of the liner material, the clamp separating the receiving portion and the storage portion of the housing; and
a lid that that translates between a closed position and an open position, the lid having at least one passage permitting air to travel through the lid.

13. The waste disposal device of claim 12, wherein the lid further comprises at least one louver biased such that the at least one passage is obstructed when the lid is in the closed position, and does not obstruct the at least one passage when the lid is in the open position.

14. A waste disposal device, comprising:
a housing having a receiving portion for retaining the liner material, and a storage portion for holding waste within the liner material, the housing having a height defined by a bottom end and a top end;
a lid translating between a closed position and an open position; and
a liner clamping system having an upper clamp and a lower clamp;
wherein the upper clamp and the lower clamp are operationally timed relative to one another such that the upper clamp closes after the lid reaches the closed position to mitigate or prevent any outward propagation of malodorous air from the storage portion of the waste disposal device.

15. The waste disposal device according to claim 14, wherein the upper clamp is in a closed position when the lid moves to an open position.
